(19) United States
(12) Patent Application Publication
(10) Pub. No.: US 2011/0087577 A1
(43) Pub. Date: Apr. 14, 2011

(54) COMPUTER-IMPLEMENTED SYSTEM AND METHOD FOR REAL ESTATE COLLATERALIZED PRIVATE PARTY LOAN TRANSACTIONS

(76) Inventors: Milton Chace Slavin, Carmen, ID (US); Michael John Slavin, Salmon, ID (US); Ashley C. Eadon, Auburn, AL (US)

(21) Appl. No.: 12/576,163

(22) Filed: Oct. 8, 2009

(51) Int. Cl. G06Q 40/00; G06Q 10/00; G06Q 50/00

(52) U.S. Cl. 705/37; 705/38; 705/316

(57) ABSTRACT

A computer-implemented system for real estate collateralized private party loan transactions comprising a database of custom property profiles that are posted by borrowers seeking to obtain financing. Each custom property profile comprises desired loan amount, type of financing sought by the borrower, purpose of the loan, and designated title company and closing agent. The system allows posting borrowers to upload photos and documents in connection with their custom property profiles and lenders to bid on custom property profiles by offering to make loans based on terms set by the lender. A lender may offer to make a loan on more than one custom property profile at a time, and if a borrower accepts an offer made by a lender, the system automatically suspends all other unexpired offers made by the lender. The lender may reactivate a loan offer that has been suspended. A method of implementing the above system.

### BACKGROUND OF THE INVENTION

1. Field of the Invention

The present invention relates generally to the field of computer-implemented inventions, and more specifically, to a computer-implemented marketplace that allows borrowers and lenders to enter into real estate collateralized private party loan transactions.

2. Description of the Related Art

The current private party real estate collateralized loan marketplace is grossly fragmented and inefficient with generally no automation. There is no established player with resources sufficient to address automation issues stemmed by current demand, let alone to meet future growth. There is no go-to source for borrowers seeking out a private party loan secured by real property, and similarly there is no go-to marketplace for investors or lenders who have available capital and are interested in investing in a real estate collateralized private party loan. As used herein, the term “private party real estate collateralized loan” refers to a loan transaction between two private parties wherein the loan is secured by real property.

The problem is twofold: first, there is no established private party real estate collateralized loan marketplace freely accessible to both private party borrowers and private party lenders. Second, there is no existing automated platform designed to handle the intricacies, orchestration and communication of all parties simultaneously involved in the bidding, funding, closing and recording of private party real estate collateralized loans.

With the absence of an established private party real estate collateralized loan marketplace, borrowers interested in securing a private party real estate collateralized loan often face difficulties in locating and interacting directly with lenders interested in such investments. Currently, the generation of this lender/borrower contact is relegated to limited personal relationships or limited networks accessed through mortgage brokers, deal brokers or other professionals. Private party loan sourcing is typically treated as a side business or a secondary avenue by these professionals after attempting to secure financing for a client through traditional bank lending sources. The reason private party financing is treated as a secondary avenue rather than a primary one is because of the inefficiency of the existing marketplace and lack of automation. As described below, there are many cases in which certain loan requests are not fit for traditional lenders but are particularly appropriate for private lenders.

Initially most borrowers seek out traditional loans through bankers and mortgage brokers. Although more progressive borrowers may seek out online services, there is currently no online marketplace for private party real estate collateralized loans. Existing sites collect and prepackage information about the borrower and distribute that information to a finite number of registered traditional lenders, but the lenders utilizing these services have no discretion in the opportunities received other than some cursory preferences they select when registering to use the website. Furthermore, there is no open online access to these platforms to allow additional lenders to register at will and browse or search for compelling lending opportunities that fit their particular lending criteria.

From the borrower's perspective, private party loans are the only option available after traditional sources have been exhausted. A private party real estate collateralized loans is, by definition, (i) a loan for the acquisition of real property, (ii) the refinancing of a real estate loan, or (iii) a home equity loan. Typical reasons why traditional lenders may deny a loan to a borrower include, but are not limited to, the following: the borrower has poor or unestablished credit; the borrower needs to get a loan funded in a short period of time; the risk profile of the loan does not fit the credit criteria banks have prescribed; the purchase opportunity is a short sale or other case where the purchase price of the property is unusually low relative to market values; the borrower may be seeking to borrow a higher percentage of the purchase price than a traditional lending source would finance; and/or the borrower has recently started a small business and does not have proven year-after-year financials.

In situations where poor credit or lack of historical financials would be a problem for a traditional bank, private lenders can focus on the collateral and either limit their risk by underwriting a low loan-to-value note or charge a higher interest rate based on the risk assumed. Banks have rigid guidelines and typically do not have the time or resources to come up with creative solutions on a case-by-case basis. Additionally, national lending institutions often have standardized guidelines for lending that fail to account for variations in local markets. Increased government scrutiny may only serve to exacerbate this problem. Private lending is unencumbered by such guidelines.

In the case of private party loans, borrowers currently may be made aware of this financing option through personal discussions with friends or with professionals such as mortgage brokers, attorneys, accountants or other individuals in a particular town or region. If the borrower engages a mortgage broker to assist in securing financing, the mortgage broker will typically (after exhausting traditional lending sources) turn to a limited group of private party lenders with whom the mortgage broker has established relationships. These types of personal relationships are necessarily limited in scope and result in a private party collateralized lending market that is essentially non-competitive. Moreover, this relationship-based business lacks automation, further limiting its scalability and rendering this model woefully inadequate to meet future projected demand.

A fairly recent option for both borrowers looking for loans and lenders looking for investments is emerging online in the form of person-to-person lending sites such as Lending Club, Prosper and Loanio. These sites allow borrowers to post loan requests and lenders to make offers to fund portions of loans, as all loans on these sites are syndicated, which means that many lenders must bid to fund small percentages of an overall loan value. In the event that the loan is not funded in whole, the borrower can choose to take a partial loan or resubmit the loan request for full funding.

Once offers on these person-to-person lending sites are entered by lenders, the lender is committed to funding a portion of the loan, which means that the lender cannot bid on more loans than he is willing or capable to fund. With this bidding limitation, it is possible that a lender will bid on an investment opportunity, wait for a period of time, and ultimately be out-bid, at which point the lender must actively search for new lending opportunity using limited searching capabilities and causing further delay in putting his money to work.

Furthermore, rather securing each investment with collateral (real estate), existing person-to-person lending sites provide to lenders credit or similar scores specific to each borrower. They also do not allow borrowers and lenders to interact directly, nor do they allow borrowers to share information and documents freely (and at the borrower's discretion) with lenders for purposes of underwriting the loan. To address deficiencies in traditional lending models and existing person-to-person online lending platforms, what is needed is an online private party collateralized real estate loan marketplace that allows borrowers and lenders to participate at will and that is both automated and scalable.

Accordingly, it is an object of the present invention to provide an online marketplace for private party real estate collateralized loans that is open to participation among all interested buyers and lenders, that allows them to communicate directly with one another, and that enables a lender to make multiple loan offers on multiple loan requests simultaneously without being overextended. Allowing lenders to make multiple loan offers simultaneously without risk of overextension increases the chances that they will be able to consummate a loan transaction within a given period of time. It is a further object of the present invention to provide an online marketplace that allows potential lenders to search for investment opportunities most likely to suit their lending criteria and meet the borrower's needs at the same time. It is yet another object of the present invention to provide a feature that assists borrowers in identifying for posting documents that will be of particular interest to lenders given the type of property listed and the type of financing requested.

### BRIEF SUMMARY OF THE INVENTION

The present invention is a computer-implemented system for real estate collateralized private party loan transactions comprising a database of custom property profiles that are posted by borrowers seeking to obtain financing; wherein each custom property profile comprises desired loan amount, type of financing sought by the borrower, purpose of the loan, and designated title company and closing agent; wherein the system allows posting borrowers to upload photos and documents in connection with their custom property profiles; wherein the system allows lenders to bid on custom property profiles by offering to make loans based on terms set by the lender; wherein a lender may offer to make a loan on more than one custom property profile at a time; wherein if a borrower accepts an offer made by a lender, the system automatically suspends all other unexpired offers made by the lender; and wherein the lender may reactivate a loan offer that has been suspended.

In a preferred embodiment, the system allows the posting borrower to add or remove photos and documents from the custom property profile after it is posted, and lenders who have made loan offers on the custom property profile are automatically notified of the addition or removal of photos and documents. Preferably, the system allows the posting borrower to modify the desired loan amount, type of financing sought by the borrower, and purpose of the loan, and the custom property profile is automatically delisted if the posting borrower modifies the desired loan amount, type of financing sought, or purpose of the loan.

In a preferred embodiment, the system allows the posting borrower to delist the custom property profile at any time. Preferably, the custom property profile includes an expiration date, and the custom property profile is automatically delisted after the expiration date.

In a preferred embodiment, the documents uploaded by the borrower include appraisals, home inspection documents, title insurance policies and title reports. Preferably, the system further comprises an automated notification feature that determines what types of documents should be uploaded in connection with a particular custom property profile and prompts the posting borrower to upload such documents.

In a preferred embodiment, when an offer is accepted by a posting borrower, all other lenders who have made offers on the same custom property profile are automatically notified, and a request for closing is sent automatically to the designated title company and closing agent. Preferably, lenders may change the terms of their loan offers in real-time.

In a preferred embodiment, all loan offers are viewable by registered and non-registered users. Preferably, the system further comprises a discussion feature that allows borrowers and lenders to communicate directly with one another through discussion comments. The discussion comments are preferably viewable by registered and non-registered users.

In a preferred embodiment, each custom property profile further comprises a document vault; the documents uploaded by the posting borrower in connection with the custom property profile are contained in the document vault; the system allows a lender to request access to documents in the document vault; the system allows the posting borrower to grant or decline a request for access to documents in the document vault; and if the posting borrower grants a lender access to the documents in the document vault, the system automatically provides the lender with access to the documents in the document vault. Preferably, a lender may elect listening lender status with respect to one or more custom property profiles, and a lender with listening lender status is automatically notified of offers made, newly uploaded photos, newly uploaded documents, and new discussion comments with respect to those custom property profiles for which the lender is a listening lender.

In a preferred embodiment, the system calculates an internal score for each offer made on a custom property profile, and the internal score represents an estimated rate of return for the offer. Preferably, the system applies the following algorithm to calculate the internal score:

$$S = \frac{\frac{{P}_{0} * r * N}{1 - {( 1 + r )}^{- N}} + ϕ * {P}_{0} - C}{{P}_{0}} - 1$$

wherein C is closing costs paid by the lender, r is monthly interest rate, N is number of monthly payment, P₀ is principal, φ is points and S is the internal score.

In a preferred embodiment, the system allows the posting borrower to rank offers made on the custom property profile based on parameters set by the borrower, and the borrower's ranking of offers is viewable by registered and non-registered users. Preferably, the system calculates estimated monthly payments for each offer made on a custom property profile. The estimated monthly payments are preferably viewable by registered and non-registered users.

In a preferred embodiment, the system further comprises a loan wizard; wherein the system allows a borrower to provide feedback on loans made with respect to custom property profiles posted by the borrower; and wherein the loan wizard takes borrower feedback into consideration in automatically identifying for a lender loan opportunities that meet criteria set by the lender and where the borrower is most likely to accept an offer from the lender.

The present invention is also a computer-implemented method for consummating real estate collateralized private party loan transactions comprising: providing a database of custom property profiles that are posted by borrowers seeking to obtain financing, wherein each custom property profile comprises desired loan amount, type of financing sought by the borrower, purpose of the loan, and designated title company and closing agent; allowing posting borrowers to upload photos and documents in connection with their custom property profiles; allowing lenders to bid on custom property profiles by offering to make loans based on terms set by the lender; allowing a lender to offer to make a loan on more than one custom property profile at a time; if a borrower accepts an offer made by a lender, automatically suspending all other unexpired offers made by the lender; and allowing the lender to reactivate a loan offer that has been suspended.

In a preferred embodiment, the method further comprises allowing the posting borrower to add or remove photos and documents from the custom property profile after it is posted and automatically notifying lenders who have made loan offers on the custom property profile of the addition or removal of photos and documents. Preferably, the method further comprises allowing the posting borrower to modify the desired loan amount, type of financing sought by the borrower, and purpose of the loan and automatically delisting the custom property profile if the posting borrower modifies the desired loan amount, type of financing sought, or purpose of the loan.

In a preferred embodiment, the method further comprises allowing the posting borrower to delist the custom property profile at any time. Preferably, the custom property profile includes an expiration date, and the method further comprises automatically delisting the custom property profile after the expiration date.

In a preferred embodiment, the documents uploaded by the borrower include appraisals, home inspection documents, title insurance policies and title reports. Preferably, the method further comprises providing an automated notification feature that determines what types of documents should be uploaded in connection with a particular custom property profile and prompts the posting borrower to upload such documents.

In a preferred embodiment, the method further comprises, when an offer is accepted by a posting borrower, automatically notifying all other lenders who have made offers on the same custom property profile and automatically sending a request for closing to the designated title company and closing agent. Preferably, the method further comprises enabling lenders to change the terms of their loan offers in real-time.

In a preferred embodiment, the method further comprises allowing both registered and non-registered users to view all loan offers. Preferably, the method further comprises providing a discussion feature that allows borrowers and lenders to communicate directly with one another through discussion comments. The discussion comments are preferably viewable by registered and non-registered users.

In a preferred embodiment, each custom property profile further comprises a document vault; the documents uploaded by the posting borrower in connection with the custom property profile are contained in the document vault; and the method further comprises allowing a lender to request access to documents in the document vault, allowing the posting borrower to grant or decline a request for access to documents in the document vault, and, if the posting borrower grants a lender access to the documents in the document vault, automatically providing the lender with access to the documents in the document vault. Preferably, the method further comprises allowing a lender to elect listening lender status with respect to one or more custom property profiles and automatically notifying a lender with listening lender status of offers made, newly uploaded photos, newly uploaded documents, and new discussion comments with respect to those custom property profiles for which the lender is a listening lender.

In a preferred embodiment, the method further comprises calculating an internal score for each offer made on a custom property profile, and the internal score represents an estimated rate of return for the offer. Preferably, the method further comprises applying the following algorithm to calculate the internal score:

$$S = \frac{\frac{{P}_{0} * r * N}{1 - {( 1 + r )}^{- N}} + ϕ * {P}_{0} - C}{{P}_{0}} - 1$$

wherein C is closing costs paid by the lender, r is monthly interest rate, N is number of monthly payment, P₀ is principal, φ is points and S is the internal score.

In a preferred embodiment, the method further comprises allowing the posting borrower to rank offers made on the custom property profile based on parameters set by the borrower and allowing both registered and non-registered users to view the borrower's ranking of offers. Preferably, the method further comprises calculating estimated monthly payments for each offer made on a custom property profile. The method preferably further comprises allowing both registered and non-registered users to view the estimated monthly payments.

In a preferred embodiment, the method further comprises allowing a borrower to provide feedback on loans made with respect to custom property profiles posted by the borrower and providing a loan wizard that takes into consideration borrower feedback in automatically identifying for a lender loan opportunities that meet criteria set by the lender and where the borrower is most likely to accept an offer from the lender.

### BRIEF DESCRIPTION OF THE DRAWINGS

FIG. 1 is a block diagram of the system architecture of the present invention.

FIG. 2 is a flow diagram of the borrower functions of the present invention.

FIG. 3 is a flow diagram of the lender functions of the present invention.

FIG. 4 is a flow diagram of the steps involved in registering as a member, both for borrowers and lenders.

FIG. 5 is a flow diagram of the steps involved in a borrower listing an ad displaying a particular property for which the borrower is seeking financing.

FIG. 6 is a flow diagram of the steps involved in a borrower and a lender engaging in discussion concerning a particular posted property.

FIG. 7 is a flow diagram of the steps involved in modifying an ad displaying a particular property and posted by a borrower.

FIG. 8 is a flow diagram of the steps involved in delisting a previously posted ad for a particular property.

FIG. 9 is a flow diagram of the steps involved in a borrower accepting an offer by a lender to finance a loan related to a particular property.

FIG. 10 is a flow diagram of the steps involved in a lender requesting permission to gain access to due diligence materials posted by a borrower.

FIG. 11 is a flow diagram of the steps involved in determining whether a lender who has requested access to due diligence materials posted by a borrower has been granted access to such materials by the borrower.

FIG. 12 is a flow diagram of the steps involved in a lender making an offer to finance a loan related to a particular property.

FIG. 13 is a screen shot of the home page of the present invention.

FIG. 13A is an example of the display area of the home page of the present invention.

FIG. 14 is a screen shot of the user profile login page of the present invention.

FIG. 15 is a screen shot of the custom property profile page of the present invention.

FIG. 15A is a screen shot of the offers tab of the custom property profile page of the posting borrower.

FIG. 16 is a screen shot of the loan platform personal page of the present invention.

FIG. 17 is a screen shot of an example of information displayed in the display area of FIG. 16.

FIG. 18 is a screen shot of the first in a series of five graphical user interface panels displayed during the custom property profile creation and registration process.

FIG. 19 is a screen shot of the second in a series of five graphical user interface panels displayed during the custom property profile creation and registration process.

FIG. 20 is a screen shot of the third in a series of five graphical user interface panels displayed during the custom property profile creation and registration process.

FIG. 21 is a screen shot of the fourth in a series of five graphical user interface panels displayed during the custom property profile creation and registration process.

FIG. 22 is a screen shot of the fifth in a series of five graphical user interface panels displayed during the custom property profile creation and registration process.

FIG. 22A is a screen shot of an example of information displayed in the display area of FIG. 22.

FIG. 23 is a screen shot of the submit loan offer page of the present invention.

FIG. 24 is a screen shot of the search results page of the present invention.

FIG. 24A is a screen shot of an example of information displayed in the display area of FIG. 24.

### DETAILED DESCRIPTION OF INVENTION

### A. Overview

The present invention is an online marketplace where borrowing parties, including borrowers and borrower agents, and lending parties, including lenders and/or lender agents via a computer network, may find each other and consummate collateralized real estate financing transactions. In a preferred embodiment, the system of the present invention comprises web-based, non-downloadable software that runs on a browser.

The present invention differs from prior art in that lenders and borrowers may voluntarily participate without any preconditions, lenders and borrowers may communicate directly with one another, and lenders may offer to finance more than one transaction simultaneously. Upon posting a loan request (i.e., a custom property profile), borrowers are assisted by an automated education and notification system that—based on the type of financing the borrower is seeking and the type of property the borrower is trying to finance—helps the borrower post the appropriate information to his custom property profile to streamline the lender's loan evaluation underwriting process. This feature provides active notification and helpful reminders of a possible incomplete custom property profile to posting borrowers. In addition, the present invention incorporates an automated function that prevents lenders who have made multiple offers on multiple loan requests from becoming overextended. Once a loan offer made by a particular lender is accepted by a borrower, all other loan offers made by that lender are suspended. The lender may reactivate these loan offers at his or her discretion.

The present invention also differs from traditional lending models in that loan transactions are consummated in real-time, allowing borrowers and lenders the opportunity to act on opportunities they might otherwise lose. The present invention allows borrowers to make new loan requests and/or alter the terms of their loan requests, and it also allows lenders to make new offers and/or refine the terms of their offers, all in real-time.

With the present invention, borrowers have access to an online community of private lenders that is significantly larger than current alternatives in the collateralized lending space, and lenders have direct, transparent and unlimited access to a multitude of private lending opportunities. The database of the present invention (referred to as the “properties database”) serves as the means by which borrowing and lending parties may find one another. The borrower may solicit offers (i.e., make a loan request) by posting a custom property profile to the properties database. The lender may browse or search custom property profiles for specific loan criteria or other attributes with which the lender is familiar. This unprecedented and unrestricted level of access to both borrowers and lenders results in a more efficient marketplace than current alternatives. Rates and terms are set by the lenders and may vary per each individual loan; both borrowers and lenders have access to this information, which serves as an indicator of the current market given the property type or geographical location of the property serving as collateral for the loan. The real-time marketplace of the present invention thus provides a truly competitive market for rates and terms of private party collateralized loans, unlike current models.

To participate in the marketplace of the present invention, both potential borrowers and potential lenders must first become registered users of the loan platform. A potential borrower must become a registered user before posting a loan request, or custom property profile, to the properties database. Potential lenders (registered or unregistered) can browse the posted custom property profiles, use search functions to locate posted custom property profiles, or use the loan platform's “loan wizard” (described more fully below) to perform specific searches based on lender criteria to locate loan requests they find to be appealing investments. A lender must be registered to make an offer, submit discussion comments, become a listening lender, request access to the document vault of a custom property profile, and save search criteria.

The properties database contains user information, custom property profiles, offers, discussion comments, photos, documents, information regarding document access, title company information, escrow company information, financial information and internal offer score values. It is accessible in varying degrees to the general public and registered users. Registered users include borrowers, lenders, and agents of borrowers and lenders. Although the general public can perform browsing functions, searching functions and use the loan wizard, only registered users may access the functions of any given custom property profile. As discussed more fully below, these functions include, but are not limited to, participating in discussions, requesting access to view documents in the document vault, making an offer, becoming a listening lender, saving search criteria, posting and updating custom property profiles, uploading photos and documents, delisting and relisting custom property profiles, calculating monthly payments, rating offers received, accepting offers, and granting or denying access to the document vault. As used herein, the term “offer” means an offer made by a lender to finance a loan, and the term “document vault” means a secure potion of a custom property profile where the posting borrower can upload documents, access to which is granted only to registered users of the site by the borrower who posted the custom property profile.

Once the potential lender locates a loan request that meets his investment criteria, he can submit an offer for that particular loan request. Offers can vary by interest rate, points, amortization period and balloon payment time frame, overall duration of the loan, and expiration date of the offer, all of which are determined by the potential lender. The lender may also enter additional terms, which will be included in the closing instructions if the offer is ultimately accepted by the borrower. These submitted offers, which can be viewed by the general public and registered users (borrowers and lenders) alike, serve as an indicator of the current market given the property type or geographical location of the property serving as collateral for the loan. The marketplace of the present invention thus provides a truly competitive real-time market for rates and terms of private party collateralized loans, unlike current existing models.

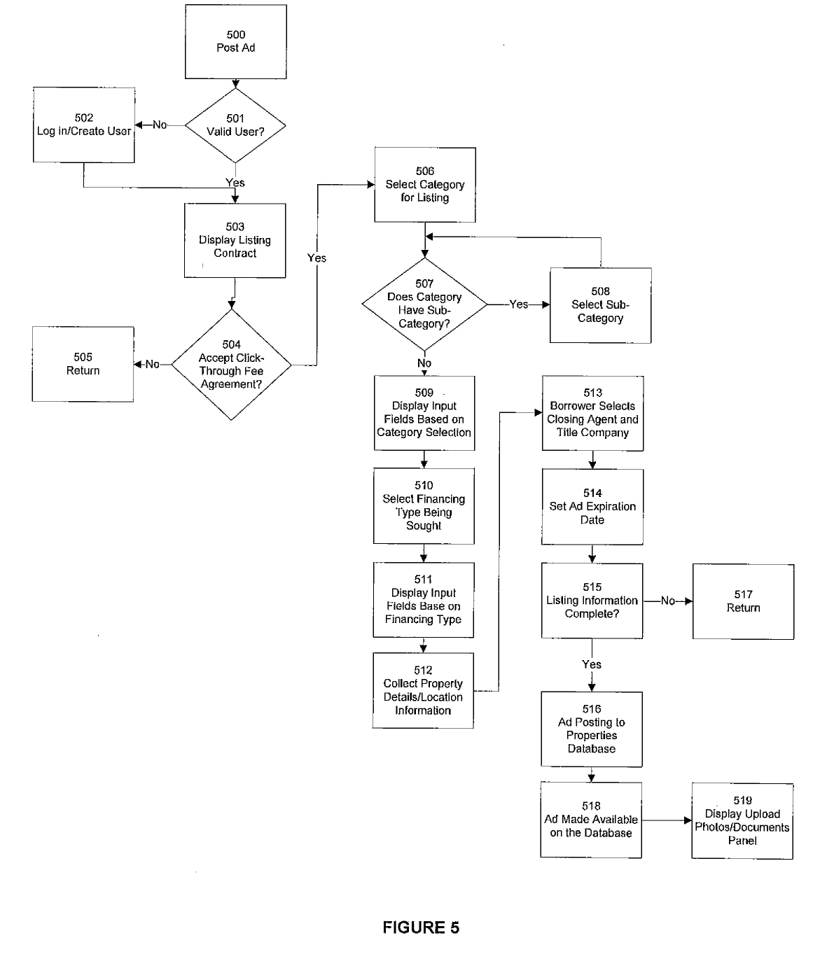

Information that must be included in a custom property profiles includes: the desired loan amount the borrower is seeking, the type of financing the borrower is seeking (e.g., first lien or position, second lien or position, etc.), the purpose of the loan (e.g., purchase of property, home equity loan, etc.), and the title company and closing agent. Other property-specific information that may be included in a custom property profile includes: property zoning information and information on buildings and improvements (i.e., number of bedrooms, bathrooms, structures, etc.). In addition, property-specific documents such as recent appraisals, home inspection documents, recent title insurance policy, title reports, water rights, plat maps, surveys, tax information, cash flow valuations and other typical due diligence documents (such as the borrower's financial information) can be uploaded to the custom property profile. The education and notification system mentioned above (and discussed in greater detail in connection with FIG. 5 below) assists the posting borrower in determining what type of documents to upload given the type of financing sought and the type of property serving as collateral. As described more fully below, the present invention allows the borrower posting these documents to restrict access to certain registered users. Photos can also be uploaded to the custom property profile by the posting borrower and are typically not restricted in terms of access (in other words, registered and unregistered users may freely access the photos associated with custom property profiles).

All of the information included in a custom property profile is intended to provide lenders with the information needed to evaluate and underwrite a loan request. Additionally, borrowers may enter estimated closing and title insurance fees and estimated property insurance costs for the property serving as collateral. This data will be used to calculate both an estimated monthly payment for a particular lender offer and an overall cost of a loan for a particular lender offer.

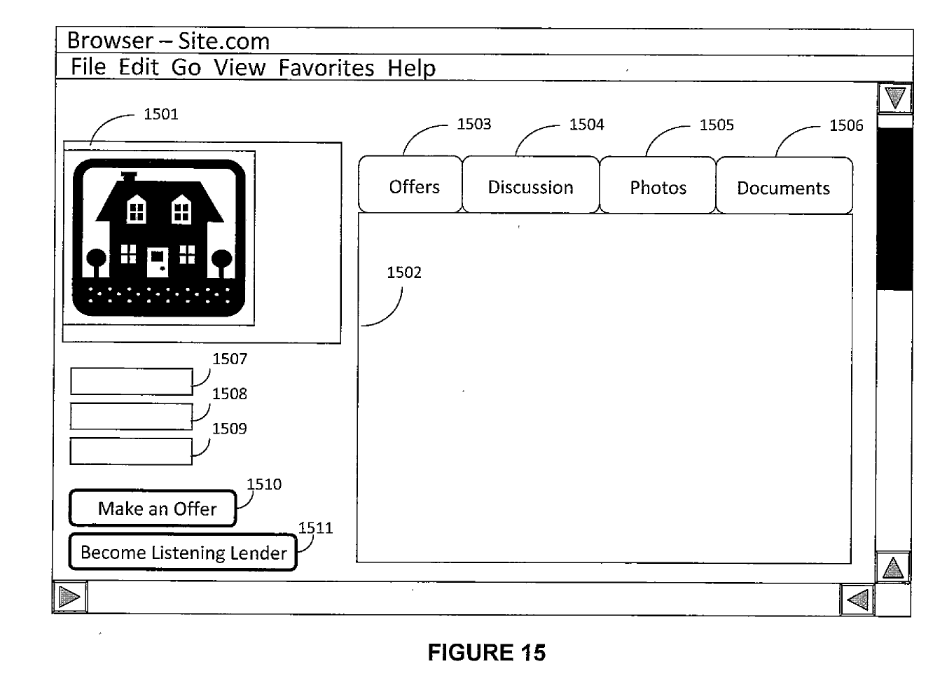

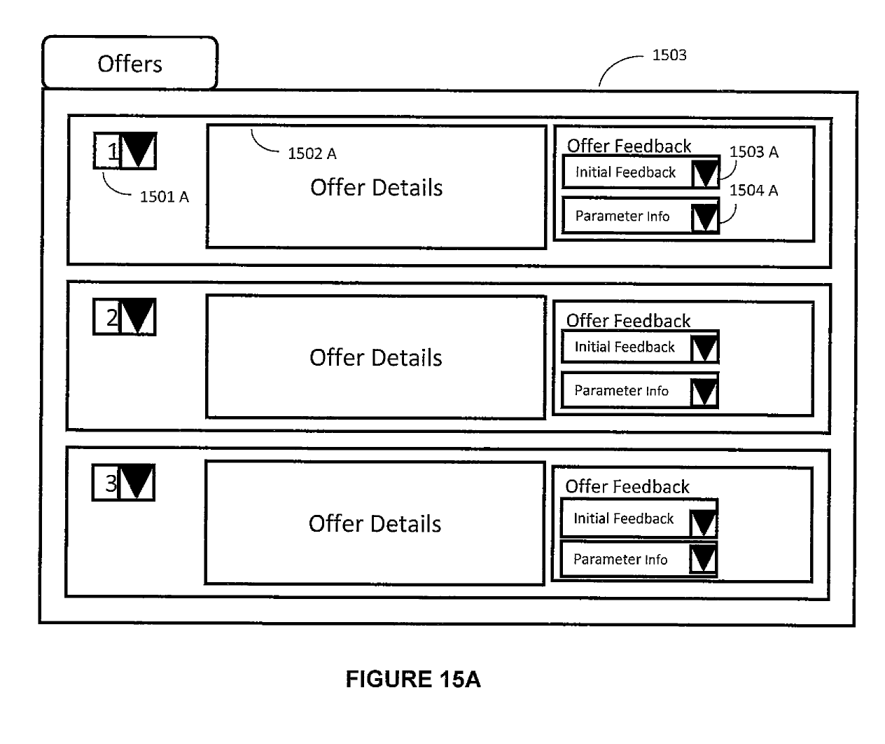

The custom property profiles are the conduit through which all interaction between the borrower and potential lenders takes place during the evaluation, underwriting and loan offering process. Once all property information is input and uploaded by the borrower, the custom property profile is saved in the properties database and searchable and viewable by the general public, as well as registered users. When a user selects a custom property profile, a graphical user interface is displayed (see FIG. 15). The required information described above is displayed prominently and constantly on every custom property profile. Specific functions available to the registered user viewing the custom property profile include (i) submitting a discussion comment using the discussion feature, (ii) viewing uploaded photos of the featured property, (iii) requesting access, granted by the borrower who posted the property custom property profile, to view any uploaded documents in the document vault, and (iv) viewing competing offers and submitting offers.

The present invention includes a discussion function where questions can be asked by lenders and answered by the borrower. For reasons of transparency, this dialogue is displayed on the custom property profile in a format similar to a blog or instant messenger and is accessible by all registered users of the loan platform, as well as the general public (including unregistered users). All lenders, therefore, have access to identical information (there is no intermediary filtering the information exchange between borrowers and lenders), promoting greater market efficiencies.

Loan terms are determined and offered by the lender and ultimately chosen by the borrower. Both the borrower and the lender have a timing function that is used to provide incentives for both parties to consummate a loan. When posting a custom profile, borrowers enter an expiration date for the loan opportunity offering if the borrower must have his loan funded before a certain date. When making an offer to finance a loan, lenders must enter a loan offering expiration date, which must be no later than the borrower's expiration date for the posted property profile.

Other terms the lender may include in a loan offer include: loan rate, amortization period, timing of a possible balloon payment, and time frame of the overall loan. The properties database, which contains custom property profiles, is browsable and searchable by both the borrower and the lender. This database is different than existing properties databases for several reasons. First, the properties database of the present invention is loan-centric. Where existing properties databases are amassed for the purchasing, selling, leasing or renting of properties, the database of the present invention is amassed as a marketplace where borrowers can post loan requests to solicit competing loan offers. The information on each property is a repository for property-specific information to be used by potential lenders for underwriting a property, not for marketing to potential owners/tenants looking to purchase or occupy a property. Second, each custom property profile, with the exception of the document vault, is viewable by the general public. This accessibility fosters a transparent marketplace where registered users and the general public can view all photos posted by the borrower, offers submitted by competing lenders, and conversations taking place between the posting borrower and the potential lenders who are asking specific questions using the discussion feature of the custom property profile. Third, as offers are submitted with varying terms, borrowers may rank these offers (see FIG. 15A) so that potential lenders may determine whether they can or desire to compete with the existing loan offer that most fits the borrower's needs.

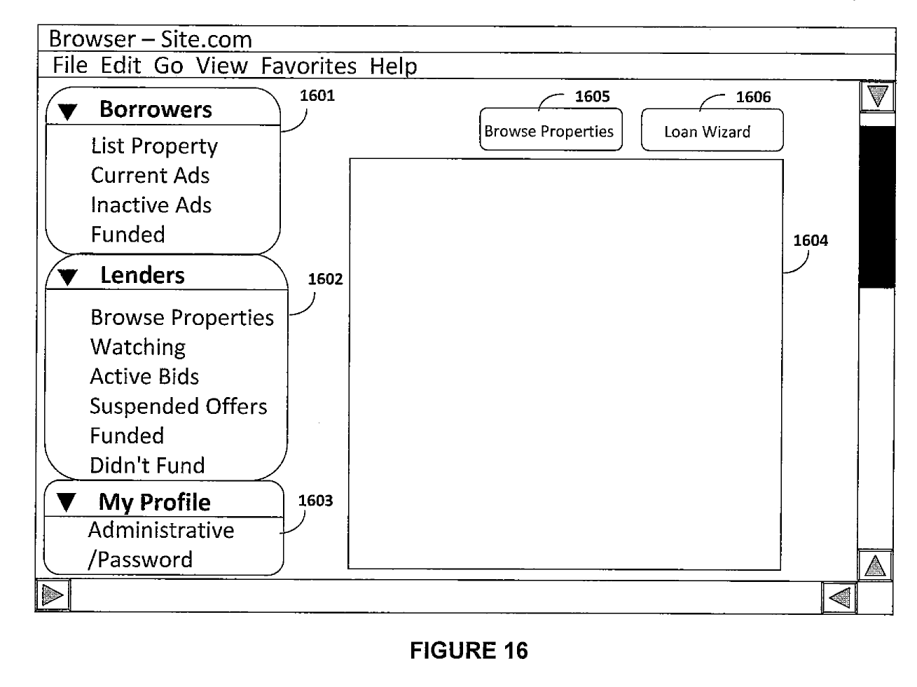

A loan platform personal page (see FIG. 16) is a graphical user interface that serves as an instrumental tool to registered users of the site. Each registered user (either a borrower or a lender) by default will have a loan platform personal page that reflects certain actions undertaken by the specific registered user. These actions include, but are not limited to: posting or making changes to a loan request; tracking offers made and discussion comments posted with respect to particular loan requests; and making an offer or electing to become a “listening lender” for a particular loan request. Listening lender status allows a lender to receive notifications in changes to the status of a particular loan request, including recently entered loan offers, recently uploaded documents or photos, and new discussion comments on a particular loan request. These pages are specific to each registered user and only accessible to the registered user.

The loan platform personal page serves as a primary conduit for both borrowers and lenders to perform actions necessary to borrow and lend on the loan platform. From this page, borrowers can manage and maintain posted custom property profiles, access saved searches, track comparable properties and loan offers being made on comparable properties, and perform other functions described below. Lenders can utilize their loan platform personal pages to browse posted custom property profiles, initiate new searches, access saved searches, access newly found and/or bookmarked custom property profiles to monitor or make offers, communicate with borrowers, and reactivate suspended loan offers. Both registered and unregistered users may browse custom property profiles, search custom property profiles, and/or use the “loan wizard” to locate loan requests with attributes matching particular loan or investment criteria.

The present invention employs multiple methods for users to interact with the database to search for a specific ad or ads (the term “ad” is used here synonymously with “loan request” or “custom property profile”). There are four main methods employed by the present invention to locate custom property profiles: browsing, simple searching, advanced searching, and complex searching. Each of these methods is discussed more fully below.

Browsing for loan requests allows a user to search custom property profiles by common logical groupings or hierarchies. For example, a user seeking a property in a specific geographic area might first look for listings in the United States, then in a particular state, and then in a particular county. Alternatively, a user could choose to view all available commercial properties and then filter those results further by limiting the results to only to commercial properties that are hotels. The browse feature uses a navigational metaphor to represent the filters applied to a database query so that users can “Go Back” or “Go Up” (remove a filter) if they feel the previous filter has reduced the number of relevant listings too far.

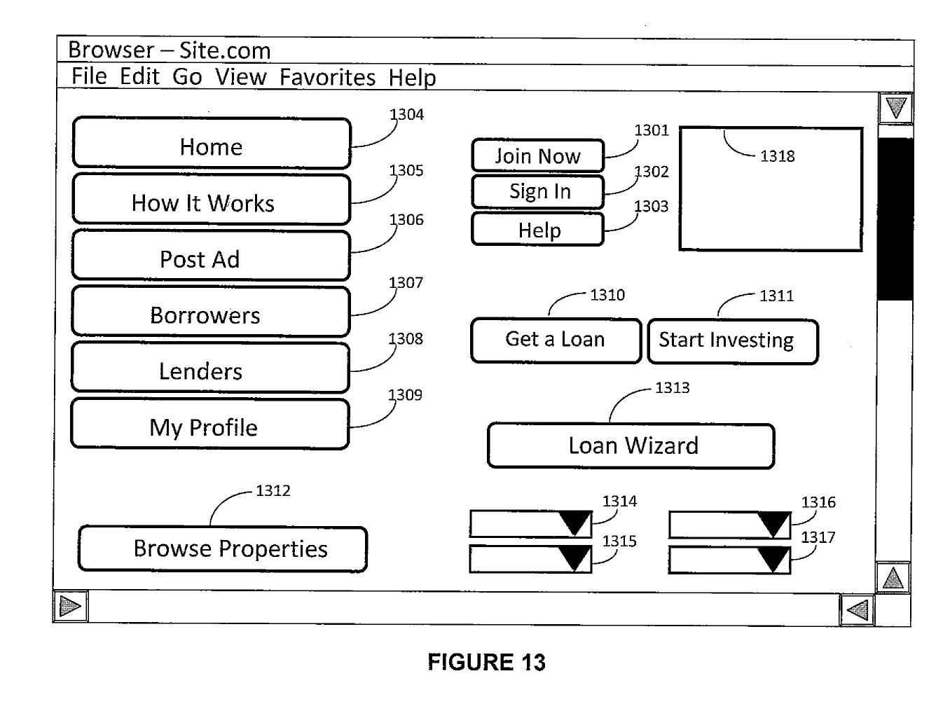

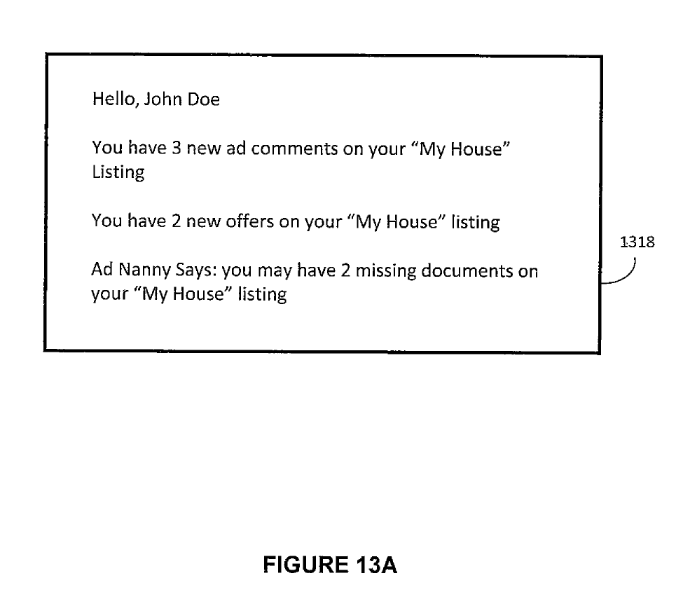

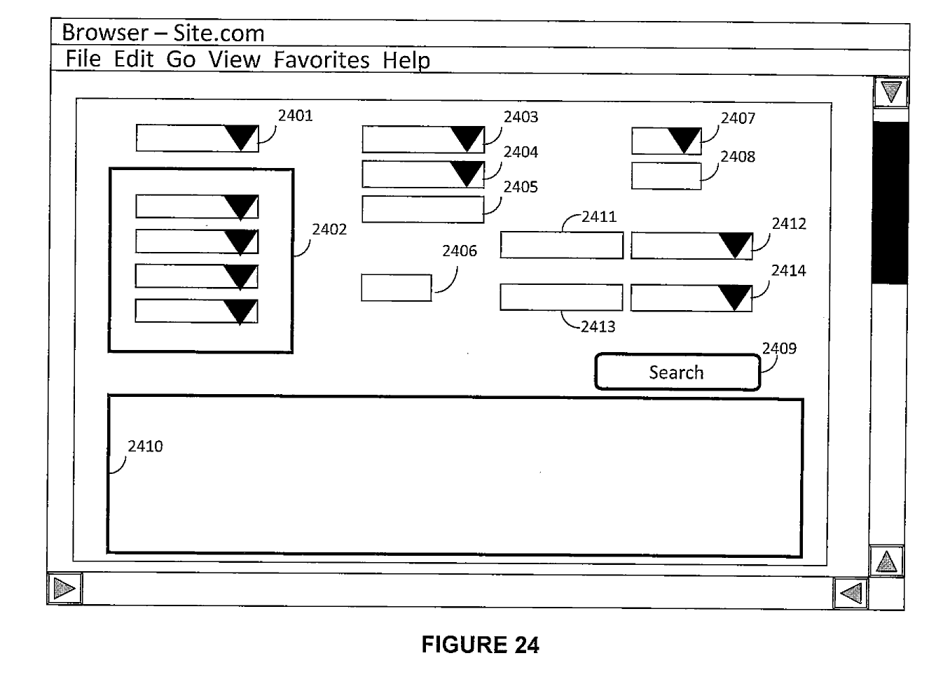

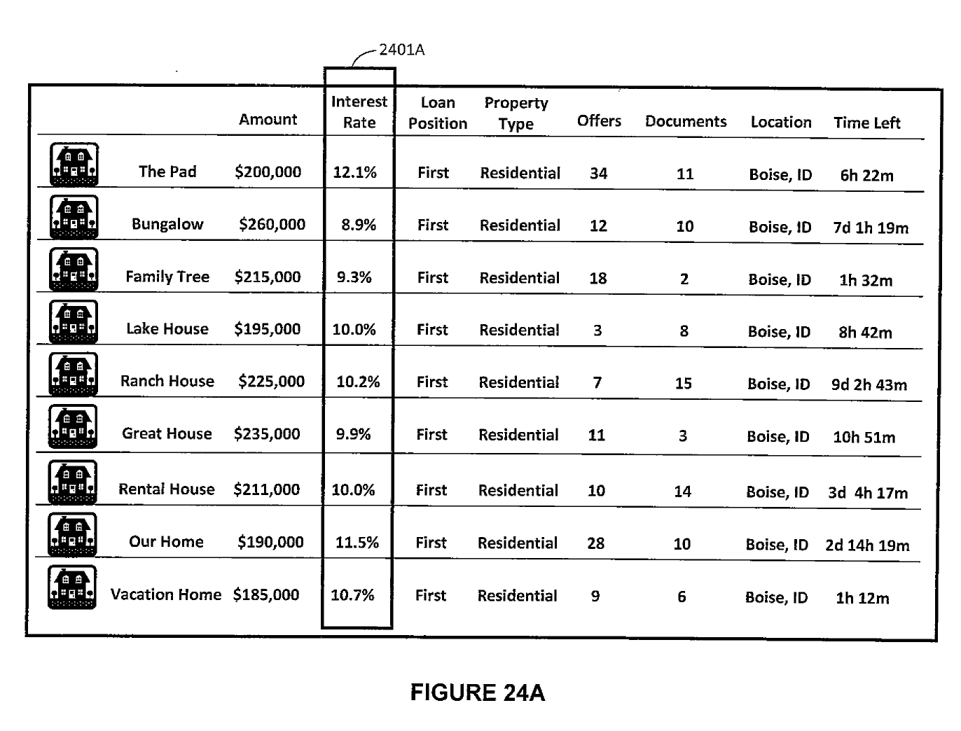

Users can start a browse by clicking on the “browse properties” button from the home page (FIG. 13) or the loan platform personal page (FIG. 16). Once either of these two buttons is clicked, a browse results page is displayed. The browse results page displays options that can be selected to help successively narrow the results of a browse. These options include, by way of example, a list of the primary five real estate categories (agricultural, commercial, industrial, residential and vacant land), property location by city and state, and loan size range. If additional options are selected, results are preferably returned displaying custom property profile information in a grid-view format (see FIG. 24A), where each row is a different loan request and columns are specific types of information. The browse results for each property preferably include a primary photo, a short description of the property, the location of the property, the number of loan offers submitted, and the time period when the loan request expires.

Simple searching is a query to the properties database. Search terms are sent to the database to find matches contained in the data for each custom property profile. Search terms can be, but are not necessarily limited to, any string of alpha-numeric characters. When a user conducts a search, some or all of the fields of the database are searched to find matches. Ads that contain matches are returned as results.

Advanced searching allows a user to restrict specific terms to certain database columns, as well as add generic restrictions to results. For example, a user can search for all ads with, a listing date greater than, equal to, or less than a specific date, while also adding other parameters to the search, such as location and loan amount.

Complex searching is the mechanism employed by the “loan wizard” to return the maximum number or relevant results to a user. Complex searching is comprised of two distinct elements: a refined search utilizing the results of an internal algorithm used to apply a score to every offer, and a second procedure to supplement these results. These two elements are described in detail below.

A search using the “loan wizard” requires three parameters: the amount of money to be lent, the duration for which the money will be lent, and the desired return on the investment (expressed simply as a percentage). These parameters will be referred to collectively as the “search parameters.”

Upon initiating a search with the loan wizard, the first element of the complex search is executed; that is, the database is queried to find ads where the amount of the loan request is within a predetermined range of the amount of money to be lent submitted as a search parameter (for example, plus or minus five percent). The results of this search are then automatically refined to exclude ads where any offer not deemed unacceptable by the borrower has an internal score value less than the search parameter called above the “desired return on the investment.” The algorithm used to calculate the internal score is discussed in detail below.

These results are then supplemented by the second element of the complex search, which is the incorporation of borrower feedback. Supplementing the search results can be performed with any parameter that has associated borrower feedback. In general terms, a user can submit a loan offer with parameters “A_{L}”, “B_{L}”, and “C_{L}”. The borrower can then provide feedback on the loan offer. For example, the borrower may indicate that parameter “C_{L}” is unsatisfactory and provide a reason why (see FIG. 15A). A user then submits a search comprised of terms “A_{S}”, “B_{S}”, and “C_{S}”. If A_{S}=A_{L} and B₅ B_{L}, but C_{S} C_{L}, then the platform tests C_{S}. If C_{S} can be deemed to be satisfactory to the borrower based upon the borrower feedback regarding C_{L}, then the ad is included in the returned results. If C_{S} cannot be deemed satisfactory, then the ad is not included in the search results.

Using the above loan wizard search parameters as an example, an offer is made on an ad that has a low value for its internal score and a duration of twenty years. The borrower then provides feedback (see FIG. 15A) indicating that the term is too long. The first element of the loan wizard search (described above) would not return this ad if the internal score is less than the search parameter called “the desired return.” If, however, the “desired return” value is less than the value of the internal scores of the other offers made on the same ad, and the search parameter called above the “duration for which the money will be lent” is less than twenty years, then the second element of the complex search (outlined above) will include the ad in the search results.

The loan wizard algorithm described above determines and returns the most competitive loan offer per property, terms and loan amount specified. This tool allows lenders to quickly locate custom property profiles with desired attributes in order to compete on investment opportunities given their investment criteria. These loan wizard searches are savable and accessed via a borrower's or lender's loan platform personal page. Borrowers may search or browse the properties database for properties with similar attributes to theirs to test the market and estimate real-time expected rates and loan terms.

Once the search results are returned, users can then click on individual custom property profiles displayed in the grid view to display a custom property profile graphical user interface (FIG. 15). This graphical user interface affords all the functions of the custom property profile described above to assist the potential lender in the underwriting and evaluation process.

Loan platform personal pages (FIG. 16) are graphical user interfaces that reflect certain actions taken by both borrowers and lenders, as explained above. These pages are username- and password-protected, and they serve as a primary conduit for both borrowers and lenders to perform actions necessary to borrow and lend on the loan platform. From this page, borrowers can manage and maintain the custom property profiles that they have posted, access saved searches, retrieve up-to-date market data relating to transactions occurring within the present invention (for example, prevailing loan rates and terms of transactions recently closed), and perform other functions described below. Lender can utilize their loan platform personal pages to browse posted custom property profiles, start new searches, access saved searches, and retrieve up-to-date market data. Lenders can also access newly found and/or bookmarked custom property profiles to make offers, communicate with borrowers, make and monitor bids, and perform other functions described below.

When an offer from a lender is accepted by a borrower, the loan platform of the present invention communicates with borrower and lender loan platform pages and closing entities (such as a title company) to notify them of the acceptance of the offer and initiate the steps necessary to consummate the transaction. This acceptance triggers a series of automated events, including, but not limited to, sending out an order for title search and insurance to a title company selected by the borrower, notifying a closing agent (if separate from the title company) of the closing, and notifying the long-term escrow/loan servicing company specified by the lender. In addition, the borrower and lender are notified electronically of the pending close of the transaction.

The system architecture, operational flow, and user interface of a preferred embodiment of the invention are described more fully below in connection with the figures.

### B. Description of the Figures

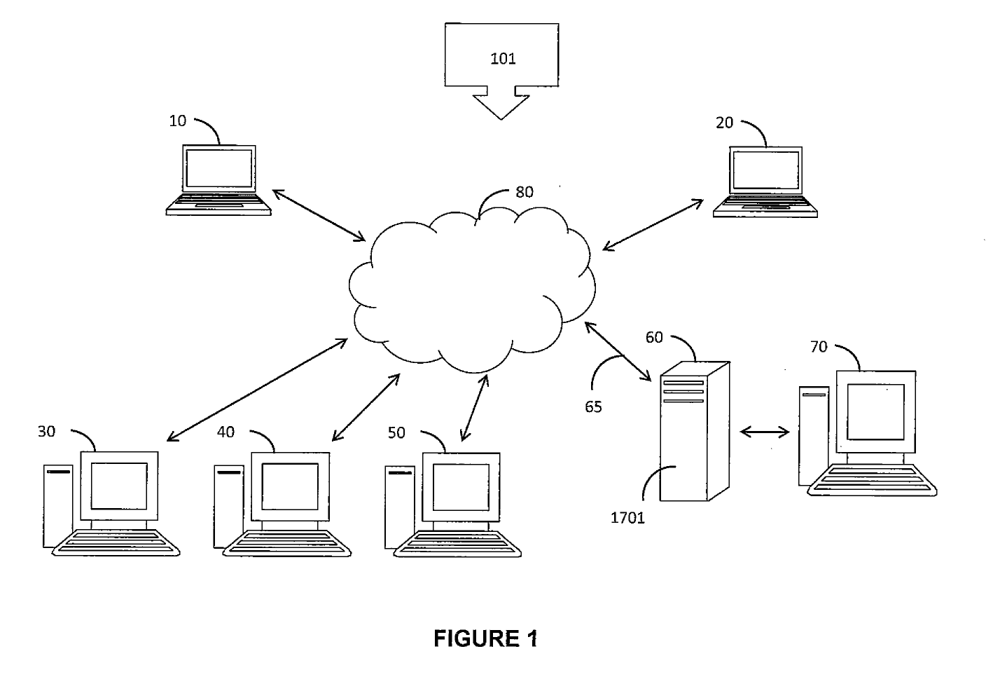

FIG. 1 is a block diagram of the system architecture of the present invention. The present invention is a loan platform 1 that provides borrowers 10 and lenders 20 —(represented by their representative computers in this figure) with access to a private party collateralized loan market over an electronic communications network 65. Borrowers 10 and lenders 20 may access the loan platform 101 through a global public network such as the Internet 80.

The loan platform 101 comprises a network server 60 containing a properties database 1701. The loan platform 101 further comprises a loan platform computer 70, which is in communication with the network server 60 over a network. The network server 60 and loan platform computer 70 may be the same or separate devices.

The loan platform 101 further comprises a title company computer 30, a closing agent computer 40, and a long-term escrow/loan servicing company computer 50. Each of these three components represents a critical business function involved with an individual loan closing. In some states, the title company may perform the duties of the closing agent.

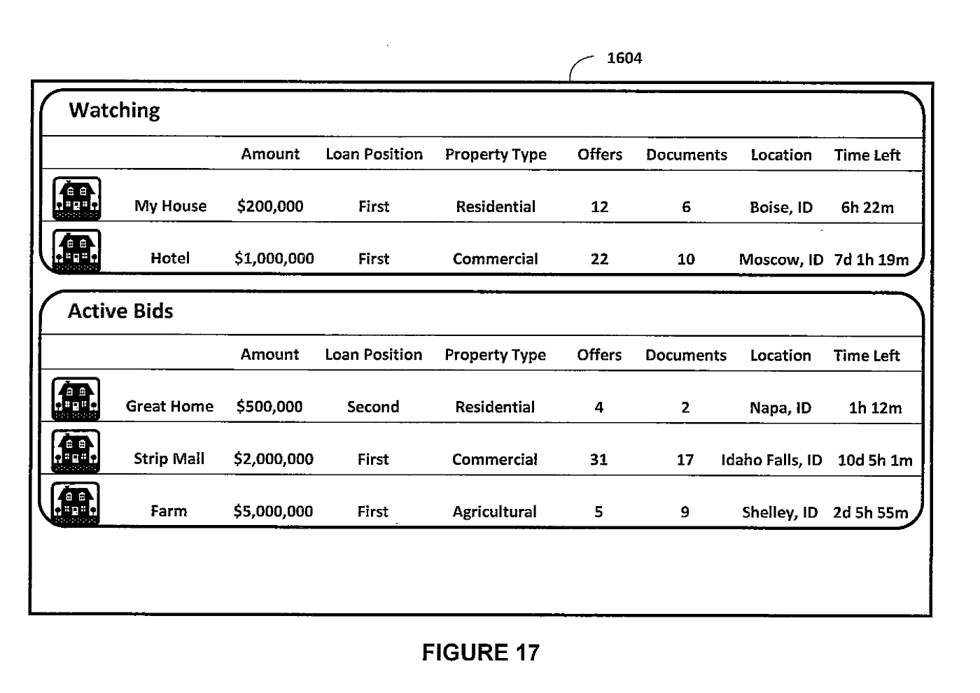

The users of the system include borrowers and borrowers' agents 10 and lenders and lenders' agents 20. In addition to facilitating direct communication between borrowers and lenders, the present invention also communicates with title companies 30, closing agents 40, and long-term escrow/loan servicing companies 50. In a preferred embodiment, the borrower 10 selects the title company 30 and the closing agent 40 when a custom property profile 1702 (see FIG. 17) is posted. The lender selects the long-term escrow/loan servicing company 50 when an offer is made, and the long-term escrow/loan servicing company 50 selected by the winning lender is notified upon acceptance of the offer by the borrower.

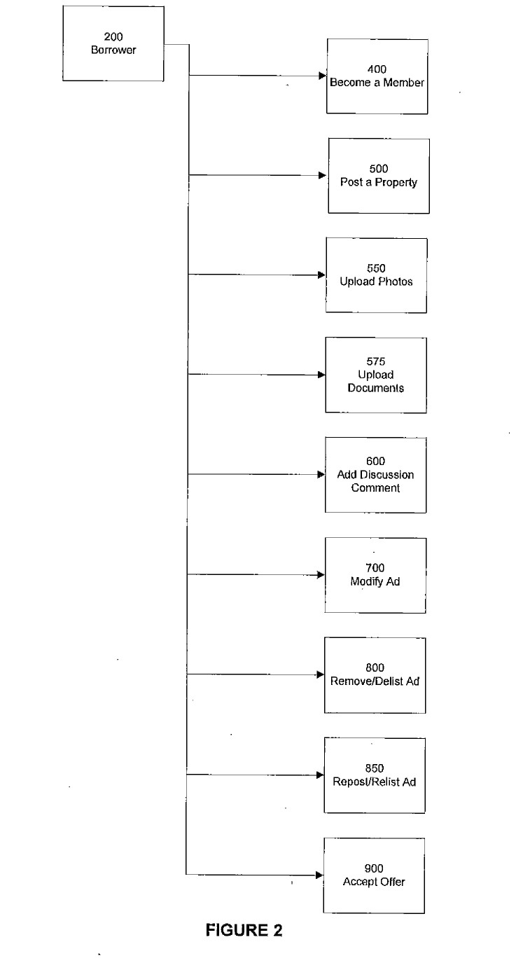

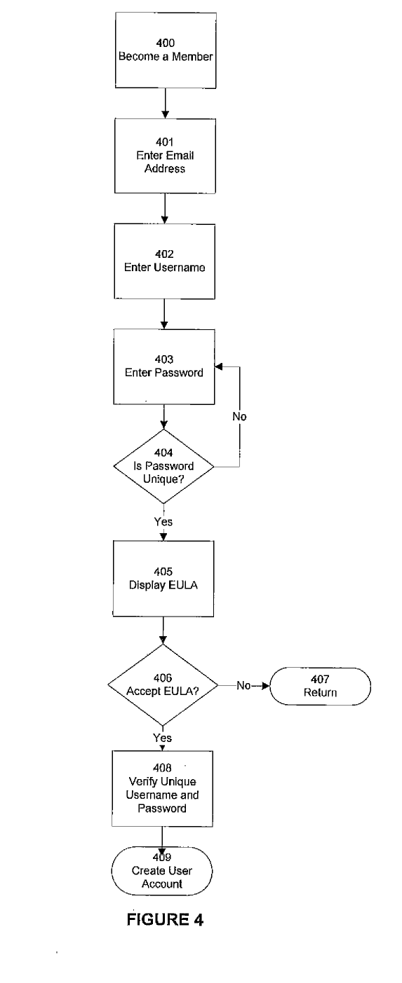

FIG. 2 is a flow diagram of the borrower functions 200 of the present invention. Before a borrower or a lender may use the present invention, he or she must become a member 400. The process for becoming a member is discussed in connection with FIG. 4.

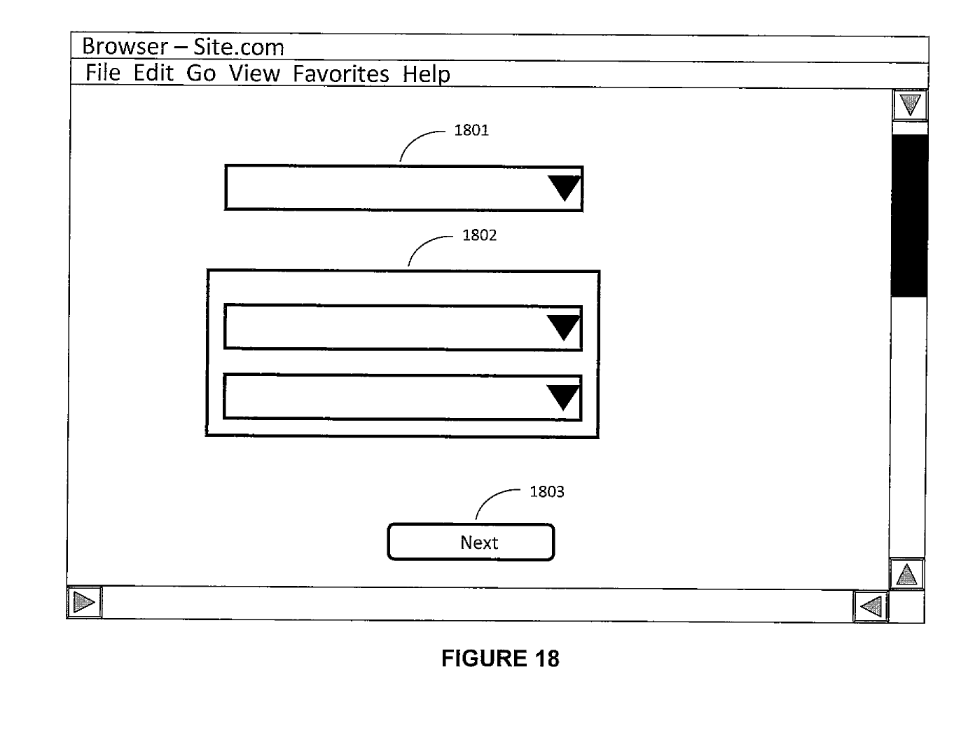

Once registered, a borrower may select the post a property routine 500 by selecting either the “post ad” button 1306 on the home page (FIG. 13) or the “list property” function on the loan platform personal page (FIG. 16). The routine is carried out with the aid of a series of five data entry screens, all of which are graphical user interfaces (see FIGS. 18-22). The information entered on these screens is transformed by the present invention into a custom property profile 1702 (see FIG. 17) that is saved in the properties database 1701. The process for posting a property is discussed in connection with FIG. 5.

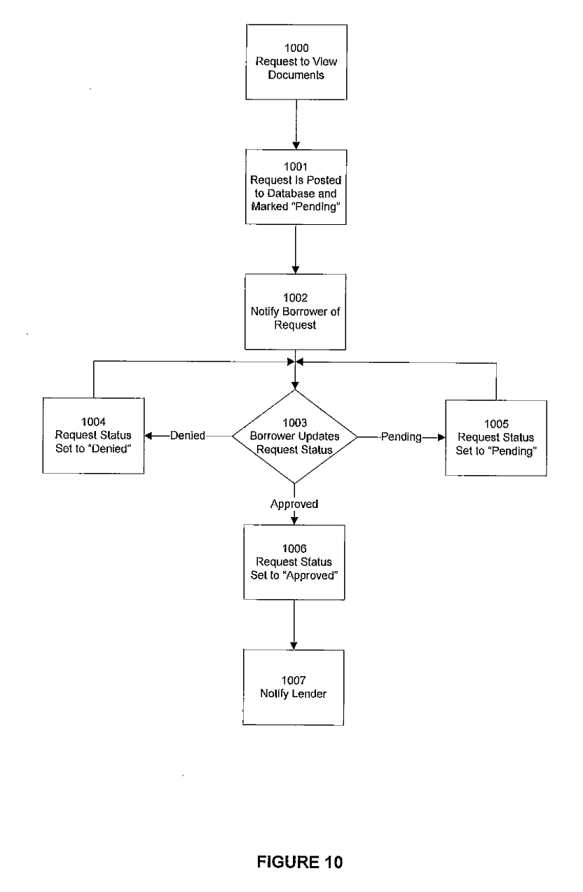

A borrower may also upload photos 550 or documents 575 to a custom property profile. When a function to upload files is selected, the borrower 10 is provided with the option of either using a text entry box to enter certain document or photo file information or browse locally on his computer to locate the desired file. In order to obtain access to uploaded documents, the lender 20 would need to obtain permission from the borrower 10, as discussed more fully in connection with FIG. 10.

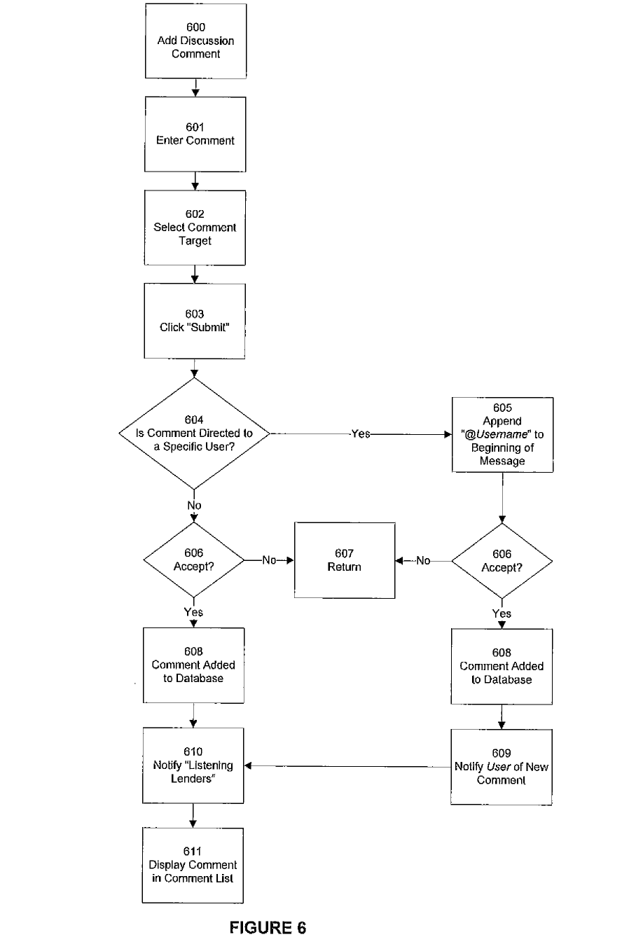

Borrowers 10 and lenders 20 may also engage in dialogue 600 during the loan solicitation and underwriting process. Once the borrower 10 posts a custom property profile to the properties database 1701, lenders 20 are able to view the posting and ask questions directly of the borrower 10 using the discussion function (see FIG. 6). The borrower 10 in turn may respond to the questions in a messaging format viewable by all registered and unregistered users in the form of a discussion tab feature 1504 (see FIG. 15) of a custom property profile 1702 (see FIG. 17). The discussion process is discussed more fully in connection with FIG. 6.

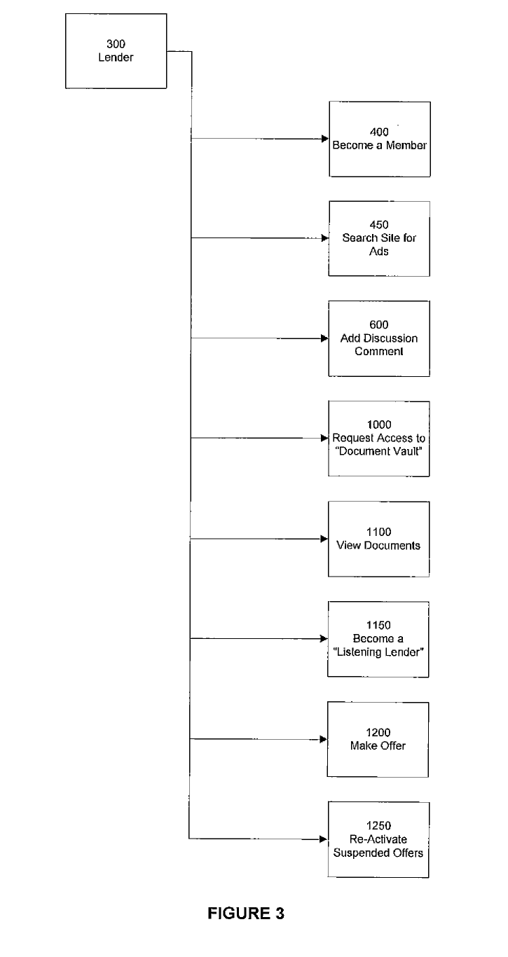

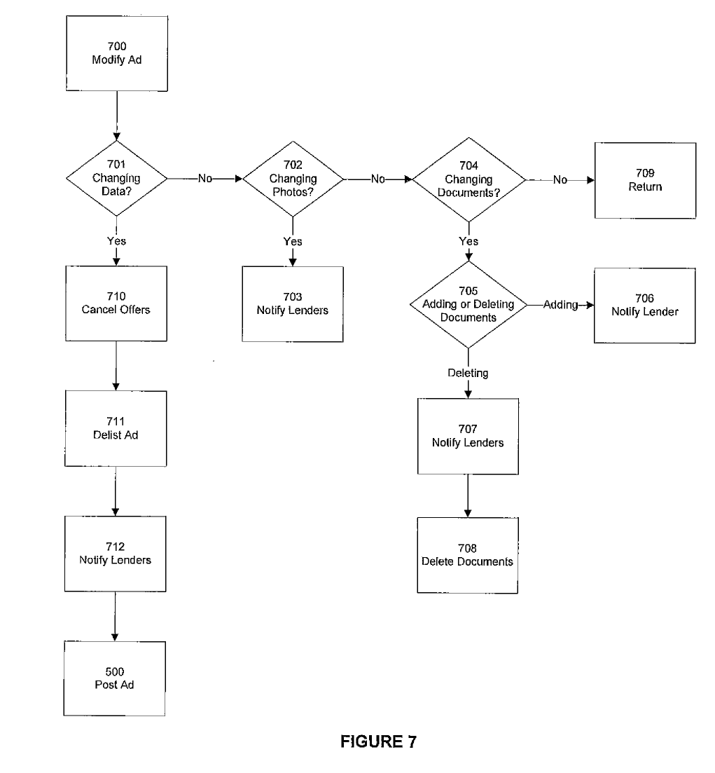

A borrower 10 may also modify an existing custom property profile 700 at any time once it has been posted. In a preferred embodiment, lenders 20 who have made an offer (see FIG. 3) are immediately and automatically notified of the change. As discussed more fully below in connection with FIG. 7, depending on the degree of the change, the custom property profile may be delisted automatically. The process of modifying an existing custom property profile is discussed in connection with FIG. 7.

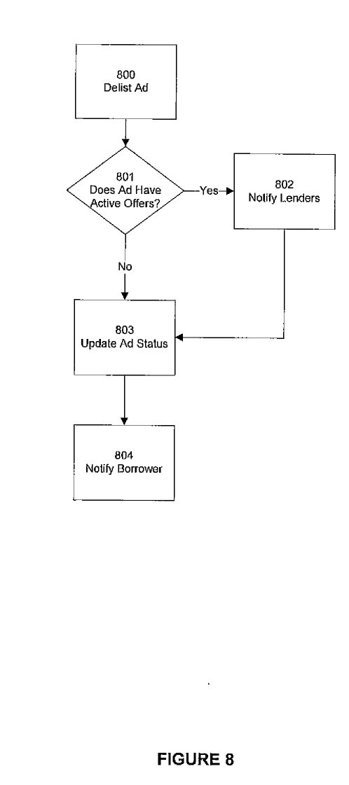

A borrower 10 may also elect at any time to delist a previously listed property (or custom property profile) 800. This would be done from the borrower's loan platform personal page (see FIG. 16). The process of delisting a property is discussed in connection with FIG. 8.

A borrower may also repost (or relist) a custom property profile 850. The process for relisting an ad is explained in connection with FIG. 8 below.

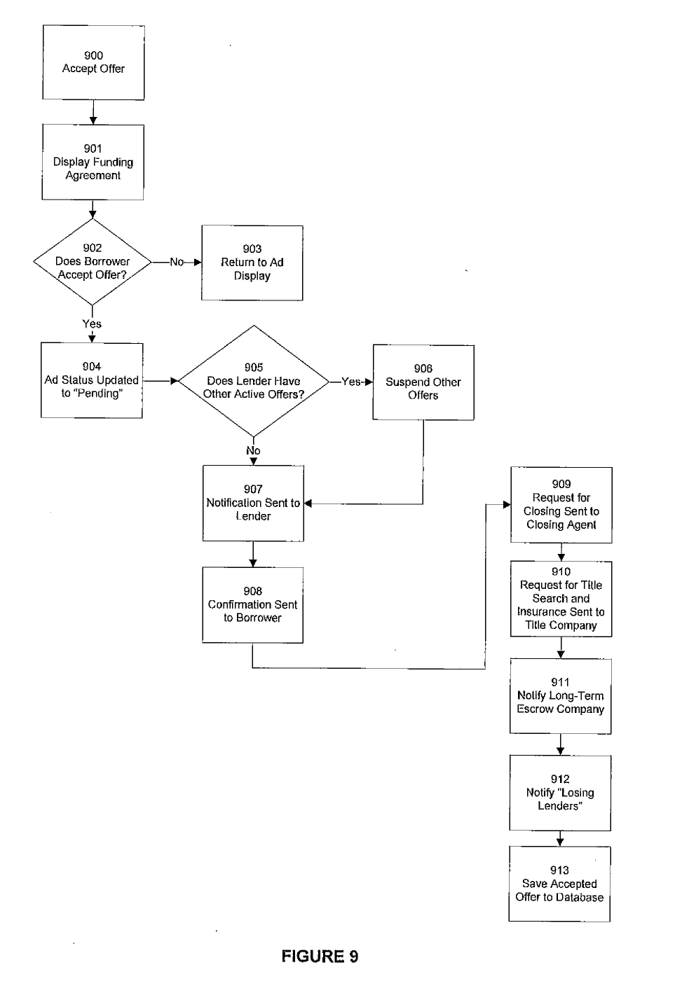

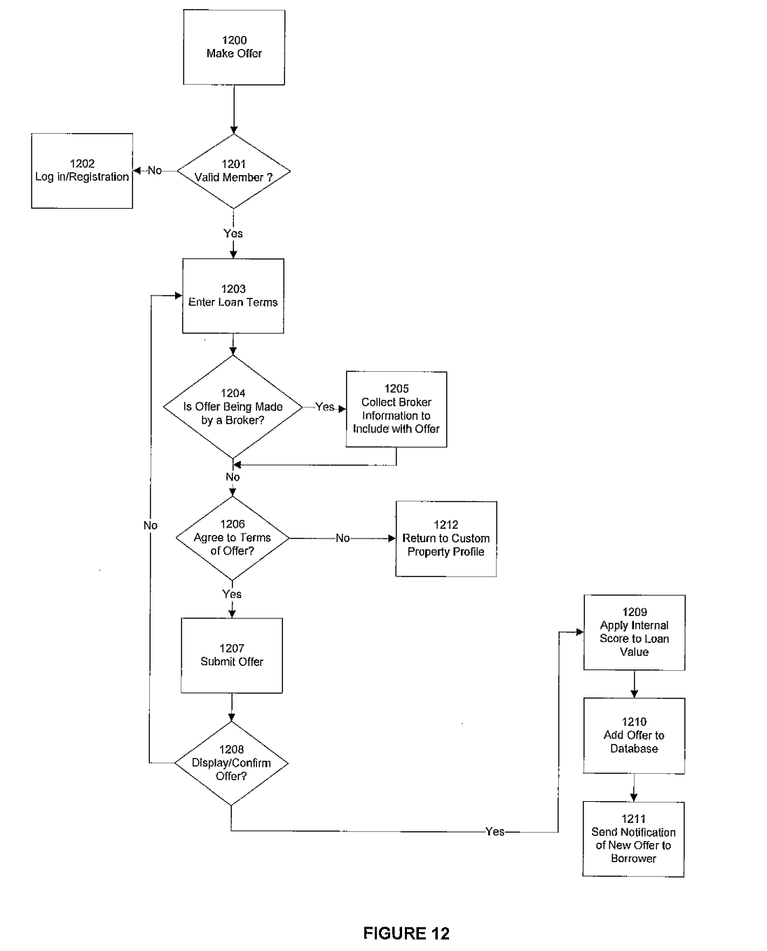

A borrower 10 may also accept an offer that has been made by a lender 900. The process of a lender 20 making an offer is described in connection with FIG. 12. When an offer is made by a lender 20 relative to a given custom property profile, the borrower 10 who posted the custom property profile is automatically notified. When a borrower 10 receives an offer from a lender 20 with terms that are satisfactory to the borrower 10, the borrower may accept the offer. The process of accepting an offer made by a lender is discussed more fully in connection with FIG. 9.

FIG. 3 is a flow diagram of the lender functions 300 of the present invention. Before a borrower or a lender may use the present invention, he or she must become a member 400. The process for becoming a member is discussed in connection with FIG. 4.

Lenders may search for ads (or custom property profiles) 450 by browsing for custom property profiles, searching custom property profiles, or by using the loan wizard, as described above. Borrowers and lenders may also engage in dialogue 600 during the loan solicitation and underwriting process. Once the borrower posts a custom property profile to the properties database, lenders are able to view the posting and ask questions directly of the borrower using the discussion function, as explained above. The borrower in turn may respond to the questions in a messaging format viewable by all registered and unregistered users in the form of a discussion tab feature 1504 (see FIG. 15) of a custom property profile 1702 (see FIG. 17). The discussion process is discussed more fully in connection with FIG. 6.

Lenders may also request access to the document vault 1000 of a particular custom property profile. The borrower who posted that custom property profile may then review the request and approve or deny access to the lender making the request (see FIG. 10). If a borrower grants access to the lender, then that lender may view the documents 1100 that are contained in the document vault of the custom property profile.

A lender may also become a “listening lender” 1150 by selecting the “become listening lender” button 1511 on the custom property profile page (FIG. 15). Any registered member of the present invention may become a listening lender of any custom property profile. This feature allows listening lenders to be notified, via their registered email addresses, of any activity occurring on any custom property profile with respect to which they have become a listening lender. Notifications are sent to the listening lender when discussion comments are made by any user, new photos are uploaded by the borrower, new documents are uploaded by the borrower, and offers are made on the particular custom property profile at issue.

Any registered user may make an offer 1200 to any posted custom property profile. Registered users are not limited to the number of offers (or the dollar amount of those offers) they can make on various listed custom property profiles. In the event an offer is accepted by a borrower, all other active offers for a particular lender will be automatically suspended. A lender may reactivate a suspended offer 1250 by accessing the suspended offer on his loan platform personal page (see FIG. 16). First, the lender would select “suspended offers” from the lender functions window 1602; the suspended offers would then be displayed in grid view in the main display area 1604. To reactivate a specific suspended offer, the lender would click on a “reactivate” button (not shown) adjacent to that offer. In this manner, lenders may elect to fund more than one loan at the same time.

FIG. 4 is a flow diagram of the steps involved in registering as a member 400. To become a member, a borrower or lender enters his or her email address 401, username 402 and password 403 from the home page (see FIG. 13, reference number 1301). If the password is unique 404, the End User License Agreement (EULA) is then displayed to the user (borrower or lender) 405, and the user must accept the EULA 406 in order to proceed with the registration process. Once the EULA is accepted, then a new user profile is created in the properties database 409. If no 407, then the user is returned to step 402 to enter a different username or to step 403 to enter a different password.

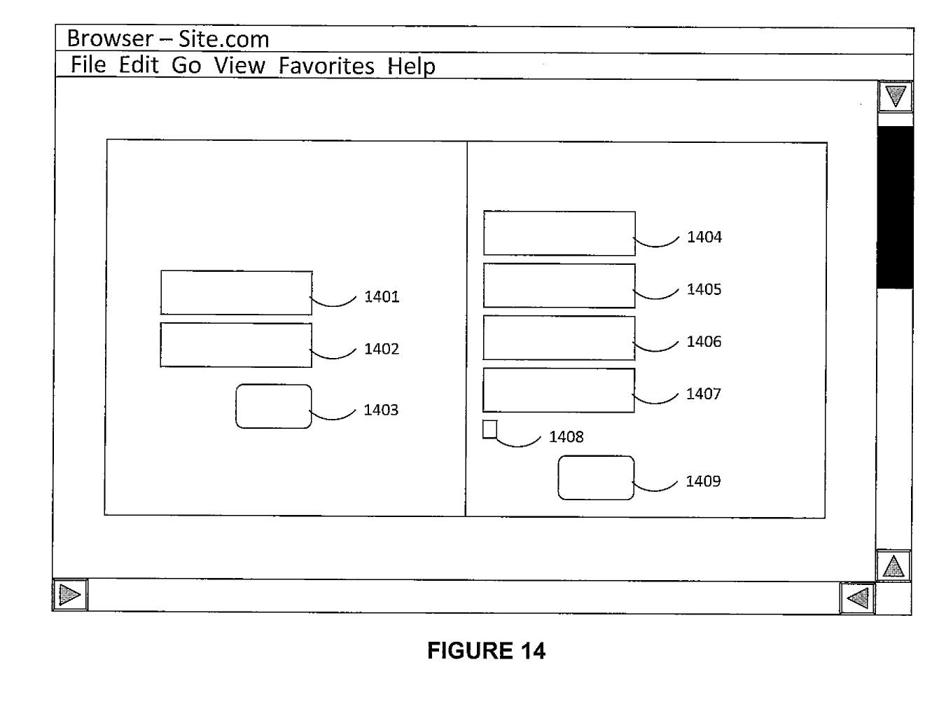

FIG. 5 is a flow diagram of the steps involved in a borrower listing an ad displaying a particular property for which the borrower is seeking financing. First, the system verifies that the borrower is a registered user 501. If not, then the user is routed to the login screen 502 (see FIG. 14). If the borrower is a registered user, then the listing contract is displayed 503; in this case, the listing contract is an agreement between the owner/operator of the loan platform and the borrower, and it typically includes a fee provision. If the borrower does not accept the listing contract 504, then the registered user will be returned to either the home page (FIG. 13) or the loan platform personal page (FIG. 16), depending on from where the user initiated the listing ad routine.

If the borrower accepts the listing contract 504, then the borrower is routed to a series of five custom property profile registration panels (FIGS. 18-22), in successive order starting with FIG. 18. Referring to FIG. 18, the user must select a property category 506 from a drop-down menu 1801. Property categories may include, for example, agricultural, commercial, industrial, residential and vacant land). Certain property categories may have one or more subcategory selections available 507; these subcategories are shown in the form of dynamic cascading drop-down menus 1802. Although only two fields (for two drop-down menus) are shown in box 1802 in FIG. 18, the present invention may encompass one to several subcategory drop-down menus. By way of example, if a user selects commercial as a property type, another drop-down menu will appear with specific commercial types of property, including office, restaurant, retail, etc. If the user then selects retail, another drop-down menu will appear with options such as power center, regional power center, shopping mall, stand alone, strip mall, etc. The user will select subcategories 508 until the property type has been defined. Once the user is done defining the property type, he will click the “next” button 1803 to proceed to the next screen.

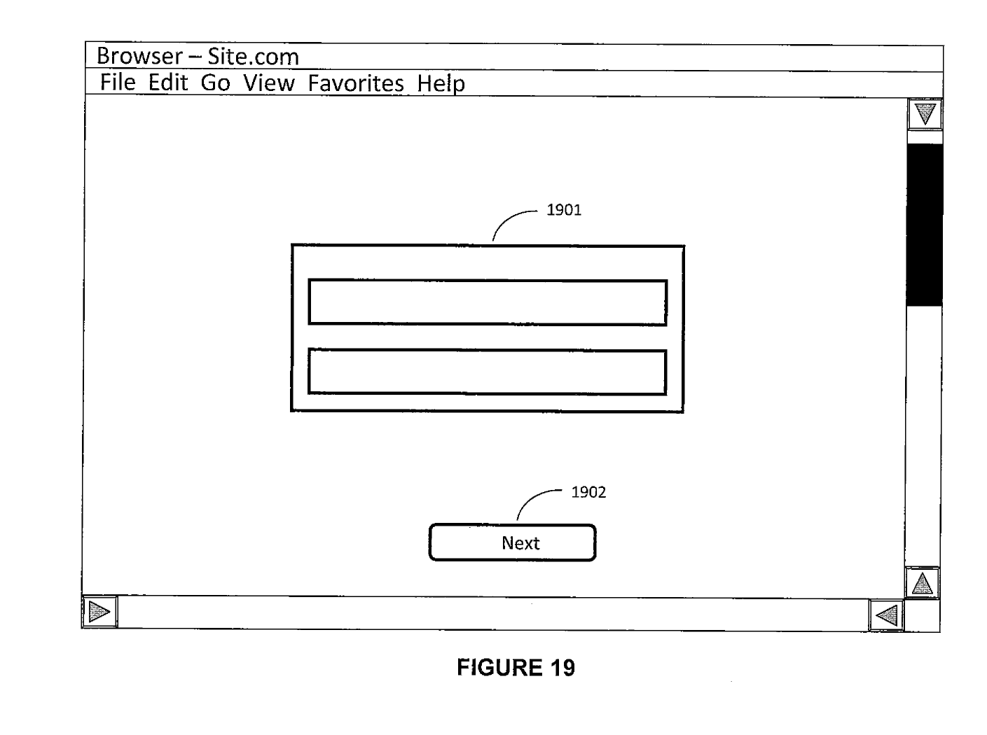

Referring to FIG. 19, property information input fields are displayed (see FIG. 19) based on the category selection 509. These input fields 1901, preferably in the form of dynamic cascading drop-down menus, may request, for example, the number and type of rooms/units, square footage/acreage, property income information, vacancy rates, easement information, information pertaining to water rights, etc. based on the property category selection. Once the property information input fields have been completed, the borrower clicks the “next” button 1902 to proceed to the next screen.

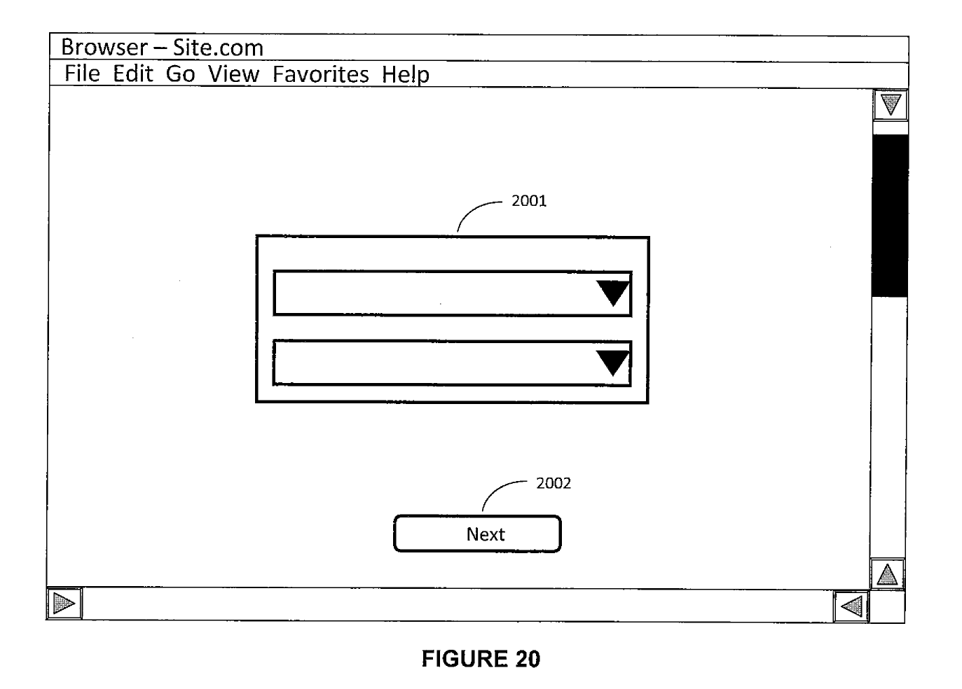

Referring to FIG. 20, the borrower must now indicate the type of financing that he or she is seeking 510. In a preferred embodiment, the borrower must select from typical financing options such as first position loan, second position loan, equity loan, etc. Based on the borrower's selections, additional input fields are displayed 511, preferably in the form of dynamic cascading drop-down menus 2001; these additional input fields will require the borrower to input information pertinent to the type of financing option sought by the borrower, for example, the amount of the loan sought, the type of loan sought (i.e., purchase, second position loan, purchase plus second position loan, refinance, equity loan, etc.), whether there are existing loans on the property, and if so, the amount of any existing loans and whether they will be paid off by the financing sought. Once finished defining the financing sought and existing financing, if any, the borrower clicks the “next” button 2002 to proceed to the next screen.

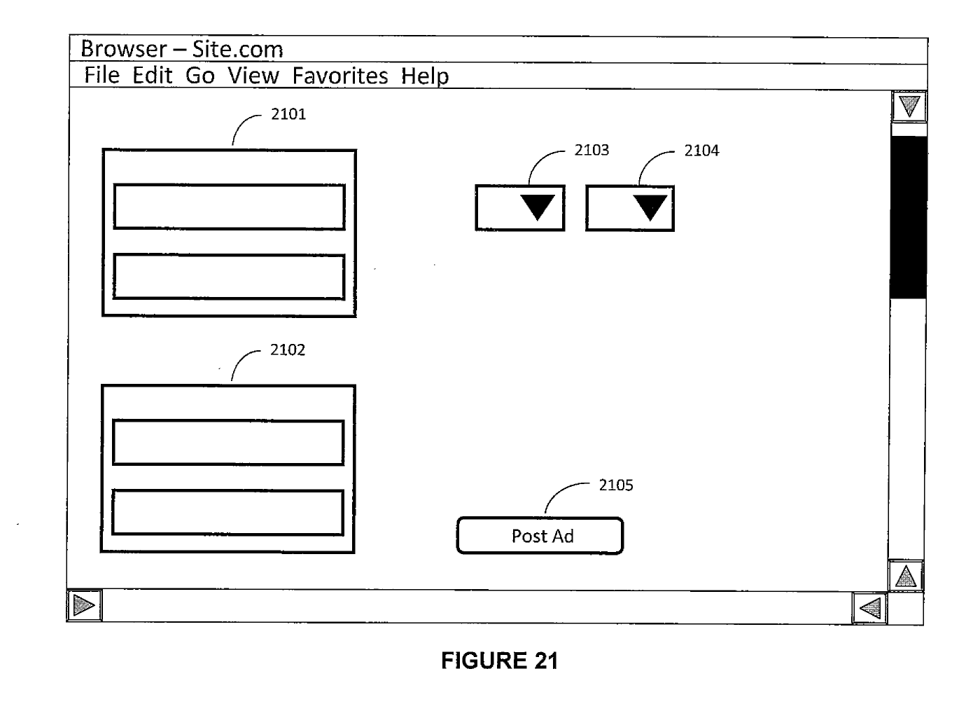

Referring to FIG. 21, the borrower must input information specific to the particular piece of property for which the borrower is seeking financing 512. Examples of such information include the physical address for the property and contact information for the borrower 2101. Once this information has been entered by the borrower, the borrower must select a closing agent and title company 513 and input the contact information for this company or companies 2102 if it has not already been input into the system (for example, by the same or another user). If the contact information for this company or companies has already been input into the system, then that information is saved and added to a list from which a registered user may select; the contact information is preferably arranged by location. The borrower must also set an expiration date and time 514 in the drop-down menu boxes 2103 and 2104, respectively, for the loan funding request. Once this information has been entered, the borrower then clicks the “post ad” button 2105. The system then verifies, by checking the specific custom property profile information, that all information for the custom property profile is complete (i.e., that all required data fields have been completed), and if yes, then the ad is posted to the properties database 516. If no, then the registered user is returned 517 to the property registration screens (FIGS. 18-22), starting with the first incomplete screen in the order in which the screens originally appeared. In a preferred embodiment, the missing or incomplete information is denoted with highlighted red rectangles around the data entry fields or drop-down menus that are incomplete.

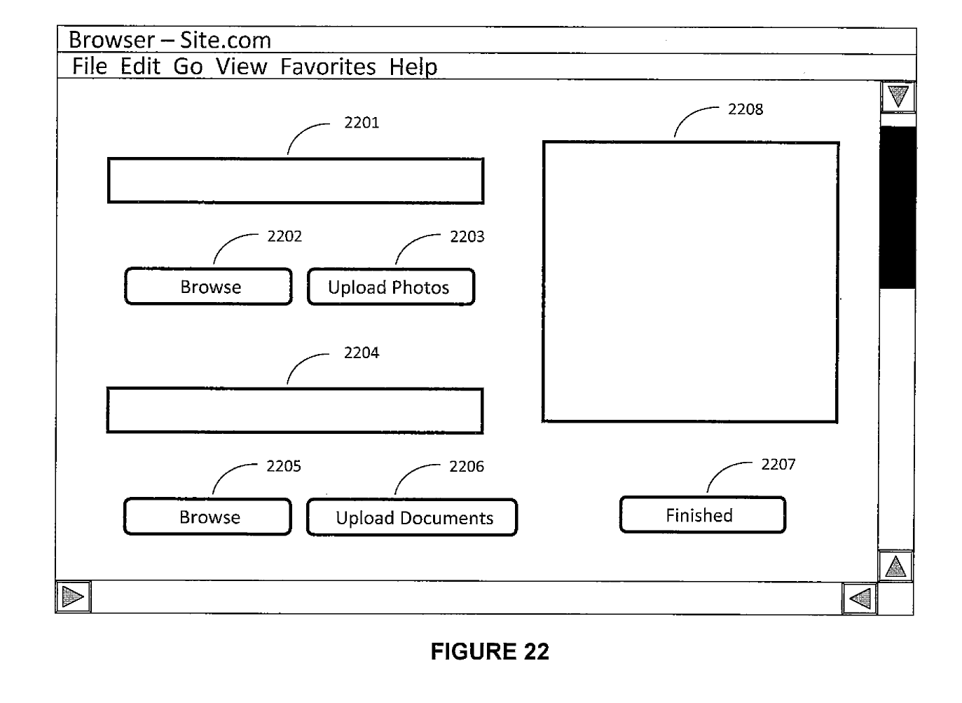

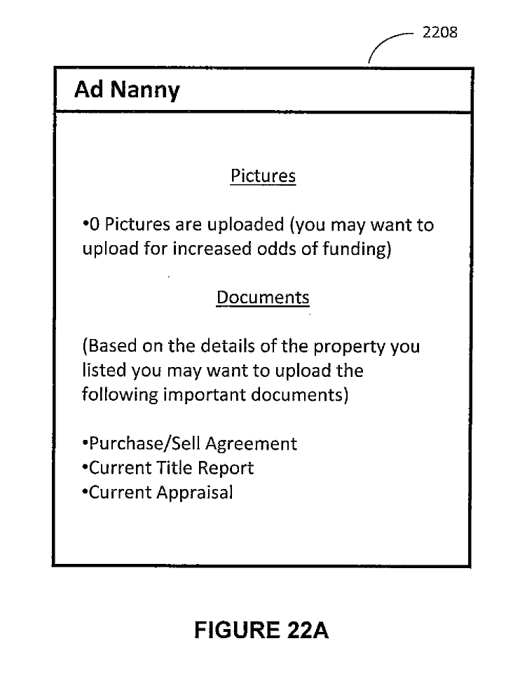

Once the ad (or custom property profile) is posted, it is made accessible in the properties database 518 for searching, browsing, viewing, interacting and the other functions described above. The expiration date is preferably prominently displayed on each custom property profile and serves as the final date by which all loan offers for that property may be submitted. Lenders may also set expiration dates for their offers, as long as they pre-date the borrower's active date. After the borrower clicks the “post ad” button on FIG. 21, the next screen (FIG. 22) is displayed 519. Either at this point or at any time subsequent to the posting of the custom property profile, the borrower may upload photos and documents to the particular custom property profile. This screen can be accessed by the borrower at any time by selecting “current ads” from the loan platform personal page (FIG. 16). Once the current ad or custom property profile is posted (see FIG. 15), the borrower can click on the photos and/or documents tabs, which will cause FIG. 22 to display.

Referring to FIG. 22, to upload photos, the borrower can either input the proper URL for the photo in the text entry box 2201 or browse for the photo on his computer by clicking the “browse” button 2202. Once the photo is located and the URL link is populated in text entry box 2201, the borrower can select to upload the photo by clicking the “upload photos” button 2203. To upload documents, the borrower can either input the proper URL for the document in the text entry box 2204 or browse for the document on his computer by clicking the “browse” button 2205. Once the document is located and the URL link is populated in text entry box 2204, the borrower can select to upload the document by clicking the “upload documents” button 2206. Once uploaded, the photos and documents are available for viewing from the custom property profile page (FIG. 17).

When an ad is posted, a code is applied to the ad based on the values for “Property Type,” “Use,” “Loan” and “Position.” In a preferred embodiment, this code is a sequence of four letters, one for each of these values. For example, “Property Type” has the following translation to code:

| | |
|---|---|
| Agriculture | A |
| Commercial | B |
| Industrial | C |
| Residential | D |
| Vacant Land | E |

Similar tables are constructed for “Use,” “Loan” and “Position.” A sample encoded string would be “DACB,” which would indicate the property has values “Residential,” “Owner Occupied,” “Equity” and “Second Position.” This information is used by the “Ad Nanny” feature (described more fully below) to indicate which documents should be included for an ad.

The education and notification feature of the present invention is an automated education and notification system that assists the posting borrower in ensuring that all of the documents a lender may foreseeably request during the evaluation and underwriting process. The education/notification feature (also referred to as the “Ad Nanny”) is displayed in box 2208 of FIG. 22 (see also FIG. 22A), and a smaller version is displayed in box 1318 of FIG. 13 (see also FIG. 13A). The Ad Nanny utilizes an algorithm that is triggered by multiple events, such as the initial uploading of documents, the uploading of additional documents, and the logging in of a user to his user profile via the home page. If the registered user has posted a custom property profile, then these events will trigger the Ad Nanny to employ optical character recognition (OCR) or similar technology to review all uploaded documents of a particular custom property profile. Using this technology and applying the algorithm, the Ad Nanny performs an audit of existing documents and suggests to the user additional documents that should be uploaded based on the type of property listed and the financing requested. For example, if a borrower is requesting financing for the purchase of an income property, the Ad Nanny will search the uploaded documents for a purchase/sell agreement, as well as a property income statement or similar statement with income information.

The Ad Nanny is executed either when a registered user logs into the loan platform or when documents are uploaded (either the initial upload or subsequent upload of additional documents) by the listing registered user of a particular property profile. When the Ad Nanny is executed for a particular ad, the code value for that ad is compared to a database that lists which documents correspond to each code. Then, for each document returned by this step, a database is queried, and a list of search terms for each document is returned. This list of terms is compared to the results of the OCR scan of each document. Using an encoded string, based on the ad and the specified values when listed, if and when a document is uploaded that matches the results of the search terms set out for a particular document, this matched document is compared against a list that is a resultant of the string associated with the ad. Then, if the uploaded document is a match with the list of documents of the particular ad, a message us displayed to the user indicating that he has successfully uploaded a document of a particular type. For documents included in the list that the Ad Nanny has identified as not being uploaded, the registered user of this particular property profile will be reminded of the missing documents, as discussed previously, on the home page (FIG. 13) and when uploading documents (see FIG. 22).

For example, if an ad has the code “DACE,” then the documents that are expected to be uploaded are an appraisal, a flood certificate, home inspection reports, property insurance, a survey, and a title report or title commitment. A partial list of the search terms used would include appraisal, value, flood plain, flood insurance, foundation, electrical, plumbing, windows, mold, endorsements, maps, boundaries, lot, title, etc.

FIG. 6 is a flow diagram of the steps involved in a borrower and a lender engaging in discussion concerning a particular posted property. Once the borrower posts a custom property profile to the database, lenders are able to view the posting and ask questions directly of the borrower. In turn, the borrower can respond to lender questions in a messaging format viewable by all users in the form of a discussion tab feature 1504 of a custom property profile (see FIG. 15). A lender may want to learn more about the loan preferences of the borrower or obtain additional information about the property serving as collateral for the loan. The information conveyed between borrower and lender using the discussion function can help lenders in making offers that are competitive relative to other offers by taking the borrower's loan preferences into consideration.

For either a borrower or a lender to enter a discussion comment, the user must first access a custom property profile by browsing or searching custom property profiles from the home page (FIG. 13) or the user's loan platform personal page (FIG. 16) or by accessing a custom property profile saved in a user's loan platform personal page (i.e., a custom property profile that the lender is watching). Upon selection of the discussion tab 1504 (see FIG. 15), a text entry box is displayed, allowing the user to enter a comment 601. Once a comment is entered, the user must select a target 602, either the borrower or another registered user who has made comments on the particular custom property profile for which the user is making a comment. A drop-down list, populated with the usernames of all the users who have commented on the custom property profile, as well as the username of the borrower, is provided. Once a comment is entered and a target is selected, the user clicks “submit” 602. Next, the system evaluates whether the comment is directed toward a specific user 604 (by looking to see whether a target has been selected). If yes, then the routine appends “@username” to the comment, where the username is the username of the user targeted in step 602. At this point, the user adding the comment must click accept 606. If no 607 (not accepted), then the user is returned to step 601. If the user accepts the comment 606, the comment is added to the database 608, and the user to which the comment was targeted is notified 609 of the comment via email and on the logged in user's instance of display area of the home page (FIG. 13, reference number 1318). Comments may also be posted without a target for general discussion purposes.

In step 604, if the user did not select a target in step 602 and a general discussion comment is made, the user must accept the comment 606. If the comment is not accepted, the user is returned 607 to step 601. If the user accepts the comment, then the comment is added to the properties database 608. Next, regardless of whether a target was selected, as soon as the comment is added to the database, listening lenders are notified of the comment 610 by email and in the display area of the home page (FIG. 13, reference number 1318). The comment is then displayed in the comment list 611 and is viewable from the discussion feature tab (FIG. 15, reference number 1504).

FIG. 7 is a flow diagram of the steps involved in modifying an ad displaying a particular property and posted by a borrower. To modify an ad 700, the borrower clicks the “modify ad” button on the loan platform personal page (FIG. 16). Next, the system evaluates whether any of the data that was initially input during the posting of the ad is being changed 701. If no, then the system evaluates whether any photos are being added or deleted 702. If so, then lenders who have made offers on the particular property with respect to which the photos are being changed and “listening lenders” are notified via email 703 of the changes made to the photos tab section (see reference number 1505 on FIG. 15). Next, the system evaluates whether documents are being added or deleted 705. If documents are being added, then lenders who have made offers on the particular property with respect to which the documents are being added and “listening lenders” are notified via email 706 of the added documents. Similarly, if documents are being deleted, then lenders who have made offers on the particular property with respect to which the documents are being deleted and “listening lenders” are notified 707, and the documents are deleted 708 from the custom property profile.

If no data, photos or documents are being changed, then the user is returned 709 to the loan platform personal page (FIG. 16). If data is being changed 701, then all lender offers made to the custom property profile at issue are cancelled 710, the custom property profile is delisted 711 from the properties database, and the lenders who have made an offer based on the custom property profile, as well as all “listening lenders,” are notified 712. The system then returns the borrower whose ad was delisted to the loan platform personal page (FIG. 16). In a preferred embodiment, some fields specific to the property may be auto-populated with data from the previous custom property profile (the one that was just delisted).

FIG. 8 is a flow diagram of the steps involved in delisting a previously posted ad for a particular property. First, the system evaluates whether there are any active offers for the custom property profile at issue 801. An active offer is a loan offer made by a registered user on a particular custom property profile. An offer will remain active until one of the following occurs: the end date of the offer which the submitting registered user determines expires, another offer on a different custom property profile made by the same registered user is accepted, the custom property profile for which the offer was made has been delisted by the posting registered user, or an alternate offer has been accepted by the posting registered user of the custom property profile for which the offer was intended. If so, then lenders who have made offers on the property and “listening lenders” are notified of the delisted custom property profile 802. If not, or after notification of the lenders, then the status of the custom property profile is changed to delisted 803. As long as a custom property profile is in delisted status, it is not accessible to anyone using the loan platform 101 other than the borrower who posted the custom property profile. This borrower may access the delisted custom property profile via the loan platform personal page (FIG. 16) and repost or modify the saved data and repost the custom property profile.

Custom property profiles can be reposted by the listing registered user from the registered user's loan platform personal page (FIG. 16). To relist a previously delisted ad, the registered user clicks on “inactive ads” in box 1601, which causes all inactive ads previously listed by this user to be displayed. The user then clicks a link adjacent to the particular ad he would like to repost, allowing him access to the previously input data for the particular custom property profile. The same five property registration screens (FIGS. 18-22) will appear in the normal sequence with auto-populated information displaying the previously input data.

FIG. 9 is a flow diagram of the steps involved in a borrower accepting an offer by a lender to finance a loan related to a particular property. To accept an offer, the borrower selects the “accept offer” button 1503 on the custom property profile page (see FIG. 15). Once this button has been selected, a funding agreement is displayed 901. The funding agreement states that the borrower is entering into a legally binding contract with a lender by accepting the lender's offer. The system then evaluates whether the borrower declines or accepts the agreement 902. If the agreement is declined, the borrower is returned to the custom property profile page 903. If the agreement is accepted, the system changes the custom property profile status to “pending” 904, and the changed status of the custom property profile is viewable by all users on the custom property profile page.

The system then evaluates whether other (non-accepted) offers have been made to this custom property profile 905. If yes, then the other offers submitted by lenders whose offers were not accepted by the buyer are suspended 906. Notification, congratulations and directions about next steps in the loan process are sent to the lender of the prevailing bid via email to the email account the lender 20 has registered with the lending platform 907. Confirmation of the newly accepted loan is also sent via an email message formulated by the loan platform 101 to the email address registered by the borrower 908. A request for closing, together with closing instructions, is sent 909 to the closing agent or title company that was designated by the borrower posting the custom property profile. A request for title search and title insurance is sent via email 910 to the title company specified by the borrower when the ad was posted. The long-term escrow/loan servicing company is specified by the lender at the time of making an offer, and when the offer is accepted, the long-term escrow/loan servicing company specified by the winning lender 20 is notified via email 911 and sent a copy of the closing instructions (closing instructions are based on information input by the borrower at the time the custom property profile is posted and on information input by the lend when the offer is submitted). All lenders who made offers that were not accepted are also notified via email 912. The accepted offer is saved to the properties database 913.

FIG. 10 is a flow diagram of the steps involved in a lender requesting permission to gain access to due diligence materials posted by a borrower. To request permission to gain access to due diligence materials, a lender (who must be a registered user) selects the documents tab 1506 on the custom property profile page (FIG. 15) and clicks a button (not shown) in display area 1502 to request access. When the request to access the document vault of a particular custom property profile is selected by a potential lender, a request is sent to the properties database and marked “pending” 1001. This action in turn causes the documents tab 1506 on the custom properly profile page to indicate display a “pending” status on the requesting lender's particular instance of the custom property profile page. The status of the documents tab 1506 may vary among lenders' custom property profile pages; for example, a lender may have requested and been granted access to the document vault of a particular custom property profile. When this lender accesses his custom property profile page, he will have access (via the documents tab 1506, preferably by way of hyperlinks to pdf files) to all documents uploaded to the document vault by the posting borrower. Another lender who has requested but been denied access to such documents would see the word “denied” when he selects the documents tab 1506; if the request is still pending (neither granted nor denied), he would see the word “pending.” In a preferred embodiment, the lender making the request is also notified by email of the granting or denial of his request.

A notification is sent via email to the borrower 1002 of the request, and the notification includes the requesting lender's unique username. The borrower then updates the access request 1003 with one of three options: (1) denied, resulting in setting the request status displayed in the documents tab for a particular lender to denied 1004; (2) pending, resulting in setting the request status displayed in the documents tab for a particular lender to pending 1005; or (3) approved, resulting in setting the request status displayed in the documents tab for a particular lender to approved 1006. If and only when a lender's request to access a document vault has been approved, the lender is notified 1007, and he can then access, download and print the documents posted by the buyer. In a preferred embodiment, if a lender's access request is denied, the lender is notified of the denial, and the status of the request is set to “denied.”

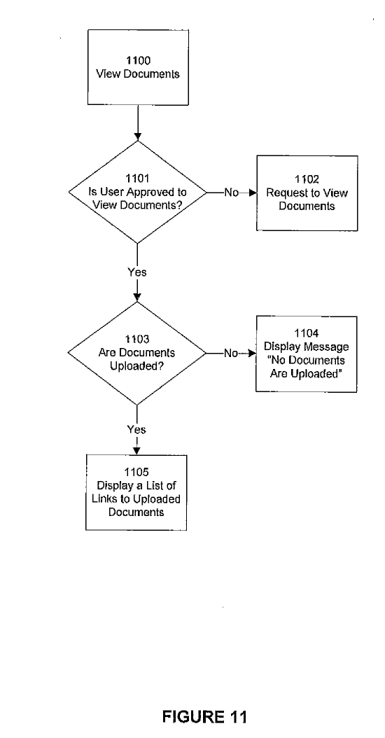

FIG. 11 is a flow diagram of the steps involved in determining whether a lender who has requested access to due diligence materials posted by a borrower has been granted access to such materials by the borrower. This function is triggered when a lender clicks on the documents tab 1506 on FIG. 15. First, the system determines whether the lender has been approved by the borrower to view documents 1101. If no, then the lender is given the option to request access 1102. If yes, then the system evaluates whether documents have been uploaded to the custom property profile by the borrower 1103. If no, then a message is displayed 1104 in the documents tab 1506 on the requesting lender's custom property profile page stating that no documents are uploaded at this time and informing the lender that he may request documents using the discussion tab 1504. If yes, then the system will display a list of hypertext markup language (HTML) links to uploaded documents 1105 in the document tab of 1506 of the custom property profile page of the lender making the request. Note that each lender has his own instance of the custom property profile page; in a preferred embodiment, the documents tab is the only tab that differs among lenders' custom property profile pages.

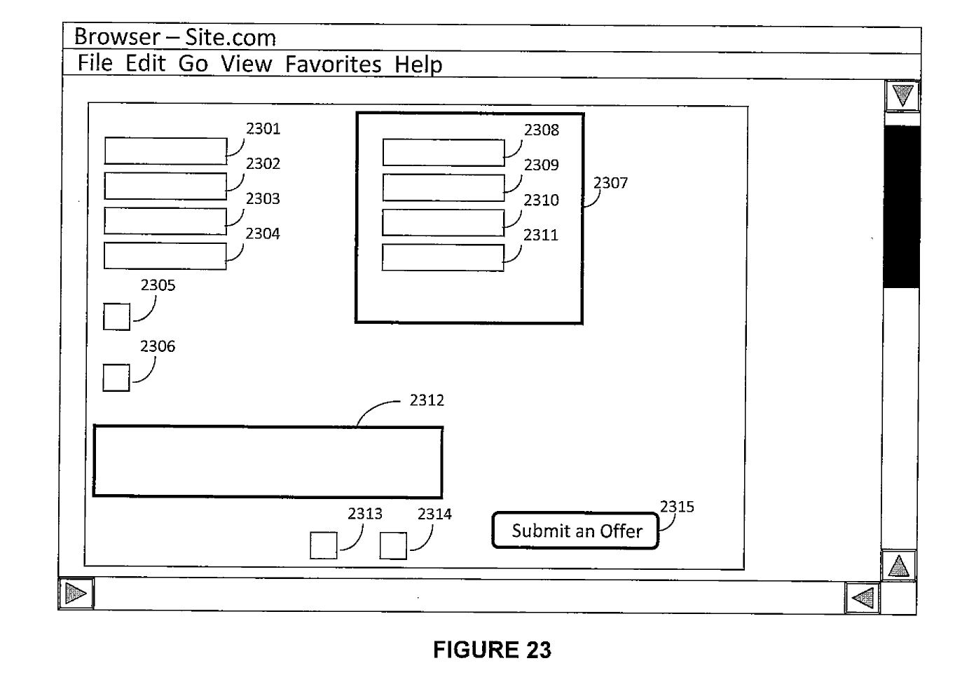

FIG. 12 is a flow diagram of the steps involved in a lender making an offer to finance a loan related to a particular property. This function is initiated when a lender clicks the “make an offer” button 1510 on the custom property profile page (FIG. 15). The system first evaluates whether the user intending to make an offer is a registered user 1201. If no, then the user is routed to the user profile page 1202 (FIG. 14). If a user is routed to this page, he or she may become a registered user by entering the information required (see FIG. 4). If yes, then a submit offer screen (FIG. 23) is displayed; this page allows the lender to specify the terms of the loan 1203, including interest rate (input into a data entry box 2301), amortization duration (input into data entry box 2302), balloon payment or payback period ranging from three to 30 years (input into data entry box 2303), default penalties automatically assessed for late payments overdue by fifteen days (input into data entry box 2304). This screen preferably includes a check box 2305 pursuant to which the lender may agree to the terms of service of the long-term escrow company that will provide the long-term escrow/loan servicing. The loan specification page also requires the offeror to indicate whether he is a broker representing a lender 1204 (with a provided check box 2306).

If the offeror indicates that he is a broker 1204 by checking check box 2306, then the system will dynamically display a broker information box 2307. In this box, the broker can enter the contact information of the individual for whom the broker is serving as an agent, including name 2308, address 2309, phone number 2310, and email address 2311.

Next, if the lender specified that he is not a broker 1204 or if he is a broker and properly input broker information 1205, then the registered user making the offer is provided with a text display box 2312 describing the consequences of entering into a legally binding contract if their offer is selected and approved by the borrower. The registered user is provided with two checkboxes 2313, 2314 by which the user can acknowledge that he has read the text in the text display box 2312 and agrees or disagrees 1206. If the lender checks box 2313, then the “submit an offer” button 2315 will be highlighted. If the lender checks box 2314, the “submit an offer” button will not be highlighted, and the lender cannot submit an offer 1207.

Once the “submit an offer” button 2315 is highlighted, the lender can submit an offer 1208 by clicking the “submit offer” button 2315. This action will cause to be displayed in a separate pop-up window a summary of the terms of the offer entered by the lender in boxes 2301, 2302, 2303 and 2304 for the lender's review 1208. If the lender selects “deny offer” in the pop-up window, the lender will be returned to step 1203 to enter or revise loan terms. If the lender selects “confirm offer,” then the system uses an algorithm to apply an internal score (described in the next paragraph) to the loan value 1209 based on estimated fee information entered by the borrower. The offer is then added to the properties database 1210, and notification of the new offer is sent to the registered borrower 1211 via email.

When an offer is made on an ad, an internal score is calculated using the offer terms provided. The algorithm for calculating the internal score requires several input parameters, which are set forth below:

C Closing costs paid by the lender (C≧0)

r Monthly Interest Rate (equal to the annual rate divided by 12)

N Number of Monthly Payments

P₀ Principal

φ Points

S Internal Score

The formula used to calculate the internal score is:

$$S = \frac{\frac{{P}_{0} * r * N}{1 - {( 1 + r )}^{- N}} + ϕ * {P}_{0} - C}{{P}_{0}} - 1$$

The internal score, S, is calculated and saved to the properties database for every offer. The internal score represents an estimated rate of return for a particular offer, given the known parameters of the loan. The internal score is expressed as a percentage that can be compared to a lender's desired rate of return. For example, if a user submits an offer on a $100,000 loan request with an annual interest rate of 10%, a loan duration of ten years, two points paid up front, and no lender paid closing costs, the internal score would be 0.6058 (or 60.58%). If the offer is accepted and the loan is paid off on schedule, the lender will have made $60,580 on his investment of $100,000.

FIG. 13 is a screen shot of the home page of the present invention. This page preferably includes a “join now” button 1301, which calls up the user profile page (see FIG. 14) from which the user may register to use the system. The “sign in” button 1302 also calls up the user profile page, where returning members may (i.e., members who have already registered) may sign in. Once a user is registered, a display box 1318 displays information unique to each registered user (see FIG. 13A). This information may include notifications of winning loan bids, notifications of new offers, and notifications of new discussion comments made to a particular custom property profile; it may also include active notifications from the Ad Nanny, as described above. The “help” button 1303 provides help tools common to most websites, such as contact information, access to a loan platform forum, access to a loan platform wiki, and access to frequently asked question.

The home page also preferably comprises a “home” button 1304, which causes the graphical user interface to return to the top-level page (the top-level page is displayed in FIG. 13). The “how it works” button 1305 takes the user to a high-level discussion of how the loan platform marketplace works; preferably, this information is provided both in a perspective specific to borrowers and a perspective particular to lenders, although both versions are available to all users (registered or unregistered). The “post ad” button 1306 triggers the process for posting an ad discussed above in connection with FIG. 5. The “borrowers” button 1307 will take the user to a series of borrower-specific pages featuring content specific to a borrower's perspective, including text, vodcasts, podcasts, etc., educating the borrower on the process of posting a loan from getting funded to paying back the loan. The “lenders” button 1308 will take the user to a series of lender-specific pages featuring content specific to a lender's perspective, including text, vodcasts, podcasts, etc., educating the lender on the process of searching for loan opportunities, funding a loan and receiving repayment. The “my profile” button 1309 allows a registered user to call up his loan platform personal page (FIG. 16). The custom property profile pages (FIG. 15) and the loan platform personal pages (FIG. 16) are the two types of pages within the present invention that are specifically tailored to the individual user in that they reflect information that is specific to that user, as described herein.

The “get a loan” button 1310 and the “start investing” button 1311 allow rapid access to educational content on getting a loan or investing for the first time. The “browse properties” button 1312 allows users to browse custom property profiles by category. The “loan wizard” button 1313 (the functions of which are described above) allows a user to enter specific loan criteria into drop-down menu boxes 1314, 1315; these menu boxes 1314, 1315 allow the user to specify lower and upper bounds of a loan size range. Box 1316 is a drop-down menu for specifying the number of years over which the lender would like to extend the loan. Box 1317 is a drop-down menu in which the lender can specify the interest rate at which he would like to loan his money. The information entered in boxes 1314, 1315, 1316 and 1317 is entered into a search algorithm, which queries the loan platform properties database for specific properties based upon the loan criteria entered. The results are returned on the search results page (FIG. 24).

FIG. 24 is the search results page that is displayed once the user clicks the “browse properties” button or uses the “loan wizard” to return search results, which display in a grid-view format in display area 2410 (see also FIG. 24A for an example), from either the home page (FIG. 13) or the loan platform personal page (FIG. 16). The search results page is also displayed when the user uses the various search features implemented throughout the platform. From the search results page, the lender may review results returned from browsing for properties, simple searching, advanced searching, or complex (loan wizard) searching. Additionally, from the search results page, the user can use the “advanced search” feature to refine search results by either modifying the initial query or adding additional search terms.

For example, a number may be submitted as a simple search, which would take the user to the search results page. The system would search and return all ads where the number appeared, including addresses, descriptions, etc. Using the “advanced search” feature on the search results page would allow the user to specify that the number was intended to be a loan amount request, which would return more relevant results to the user.

Additionally, filters may be applied to the search, allowing a user to specify, for example, that he wanted all ads with loan request amounts below a certain amount. Search filters can be applied to many search terms, such as price (above or below the amount), zip code (include a certain proximity), ad status (current or recently funded ads), etc. To utilize the “advanced search” feature, a user simply adds or modifies the terms represented by text entry boxes 2411, 2413 and then applies filters using the associated drop-down lists 2412, 2414. Although only two text boxes 2411, 2413 and two drop-down lists 2412, 2414 are shown in FIG. 24, the present invention is not limited to any particular number of text boxes or drop-down menus.

Once the user has entered all the terms he wishes to submit and applied any associated filters, the user then clicks the search button 2409. If the user feels that the search was too limited, he can remove search terms by deleting text from the box 2411, 2413 or by unselecting an item in the drop-down list 2412, 2414. The lender performs all of these actions from the search results page (FIG. 24) to locate custom property profiles for which the lender may wish to make a loan.

Specifically, the lender can select a property type by choosing from a list of property types from the drop-down menu 2401. Depending on the selection made, consistent with the listing of the custom property profile, the property type may have several subtypes. To select property subtypes, there is a dynamic cascading drop-down menu 2402, similar to those used in connection with the property registration panels (FIGS. 18-22). Other options available to the lender to narrow a search include choosing a state and city by using the drop-down menus 2403 and 2404, respectively, or entering a zip code 2405. The lender can also choose a range of miles 2406 in proximity to the city, state or zip code entered.

The search results page further comprises a drop-down menu 2407 with which the user may select the type of financing the borrower is seeking (for example, “purchase” or “refinance”) to further refine the search. A lender may input a loan amount in text entry box 2408 to return search results within a certain range (for example, plus or minus five percent) of the loan amount. Additionally, the user may select to search only active ads, inactive ads, or both, using a drop-down menu not shown on this figure. Once some or all of the information is input, the lender clicks the “search” button to return results based on the criteria entered. The results will be displayed in a grid format in box 2410. Collocating the search controls and the search results on the same page allows for an iterative refinement of the search results.

FIG. 14 is a screen shot of the user profile login page of the present invention. To log in as a returning user, the user must enter his unique username 1401 and unique password 1402 and click the “sign in” button 1403. To register to become a member, the user must enter a unique email address 1404, create and enter a unique username 1405, and create and enter a unique password 1406. In a preferred embodiment, the user must re-enter the password in text entry box 1407 to confirm that the password was entered correctly. Next, the user must read and accept the EULA by checking the check box 1408. As a final step, the user must click the “register” button 1409. When the “register” button 1409 is clicked, the system will verify that the username and password entered are unique and that the EULA check box 1410 has been checked. If any of these conditions is not satisfied, then the system will return the user to user profile page login page shown in FIG. 14; in a preferred embodiment, red text will appear in those fields that need to be corrected because the information is incomplete or invalid.

FIG. 15 is a screen shot of the custom property profile page of the present invention. The custom property profile page includes a property description with information typically contained in a conventional property listing (address, square footage, number of bedrooms and bathrooms, etc.) on a static portion of the page 1501. Other information on this page is input by the borrower when creating a custom property profile (see FIG. 5, steps 509-513). An expiration date, preferably displayed in red text, indicating how long the borrower's solicitation of loan offers will extend is displayed on the static portion of the page 1501, thereby putting a deadline on offers extended by lenders. This date is taken into consideration by the system by automatically delisting an ad (or custom properly profile) after this date has passed; at that time, the delisted custom property profile is viewable only by the borrower who posted it. A borrower may relist a delisted ad as described above in connection with FIG. 2. The system will check for completeness of data entered for each custom property profile (as described above in connection with FIG. 5), as well as intuitiveness of entries; for example, the loan amount may not exceed the purchase price of a house, contact information must be complete, a title company and closing agent (in states where closing agent is a separate party from the title company) must be specified, etc.

From the custom property profile page, users may access more specific information by selecting the offers tab 1503, the discussion tab 1504, the photos tab 1505, and/or the documents tab 1506. As each tab is selected, the display field 1502 will change to display information particular to each tab. From the offers tab 1503, users can view existing offers, including terms and interest rate. The posting borrower of a particular custom property profile may, upon selecting the offers tab 1503, review and rate offers made by lenders (see FIG. 15A); this information is used to enhance the effectiveness of the internal scoring algorithm, as explained above.

Referring to tab 1503 of a custom property profile (see FIG. 15A), offers and related information are displayed in a grid-view format where each row represents an offer and related information. The information associated with each offer includes offer rank 1501A, offer details 1502A, and offer feedback. The offer feedback box comprises an initial feedback box 1503A and a parameter information box 1504A, as shown in FIG. 15A.

The offer ranking box 1501A is only viewable on the posting borrower's custom property profile. (Registered and non-registered users would just see a fixed number in this box.) As new offers are submitted by potential lenders, they will be updated on FIG. 15A and assigned the highest rank (i.e., if there are four offers, and one more gets made, it defaults to rank number 5). The posting borrower uses the rank drop-down box 1501A to sort the offers by a newly assigned rank designated by the borrower. By ranking the offers, the posting borrower indicates a preference for which loan or loans are currently the most likely to be selected by the borrower (in other words, which loans are leading the auction).

Based on the registering borrower's ranking selection choices made in box 1501A, the order of displayed offers will change to reflect the new ranking. Display area 1502A displays the details of each offer, such as: percentage rate of loan offered, amortization period of the offered loan, balloon period or full term of the loan and prepayment or late payment penalty information, offer terms, expiration date of each offer, and the username of the registered user who made the offer. This display area 1502A is viewable by all registered and non-registered users.

The initial feedback drop-down list 1503A and the parameter information drop-down list 1504A are drop-down functions viewable only by the posting borrower. The selections made by the borrower, however, are displayed, in simple text, in the same locations as 1503A and 1504A, respectively, and are viewable to all registered and non-registered users. The initial feedback drop-down list 1503A provides the posting borrower with a list of the specific details of an offer (as mentioned above in the discussion of offer details 1502A). From this list, the posting borrower can select the offer detail with respect to which he would like to provide feedback. The parameter info drop-down list 1504A allows for further refinement or a series of provided comments based upon the offer detail selected in the initial feedback box. For example, if the borrower selects balloon period as the detail from the list provided in the initial feedback drop-down list, the parameter info drop-down list will provide a list of responses from which the borrower may choose (such as too long, too short, I was looking for a five-year balloon period, I was looking for a ten-year balloon period, etc.). Once the posting borrower is satisfied with the new rankings of the offers, be may exit the offers tab 1503, and the changes made by the posting borrower on this page will be reflected in the offers tab 1503 of the custom property profile for all users.

From the discussion tab 1504 of FIG. 15, users can view discussion comments made by both prospective lenders and the posting borrower. From the photos tab 1505, users can view photos that have been uploaded by the borrower and that depict the property. Users may also view additional due diligence documents, such as purchase and sell agreement, credit information and tax information, recent appraisal, current title report, flood certification, zoning, soils study, geotechnical study, and rent/lease agreements, if applicable. All of these documents are uploaded by the borrower to the documents tab 1506; users requesting access to such documents must be approved by the borrower, however, as explained above in connection with FIG. 10.

In addition, borrowers can enter estimated fees and costs (such as title insurance fees, recording fees, document preparation fees, and short-term escrow/closing fees) on their custom property profile pages in boxes 1507, 1508 and 1509 (although three text boxes are shown, any number of boxes may be provided). These boxes are displayed only on the posting borrower's custom property profile page. After information is input into these boxes by the borrower, the system calculates an estimated monthly payment on an offer-by-offer basis and displays that information in the display field 1502 with the offers tab 1503 selected (preferably a column entitled “estimated monthly payments” is added to the grid view for each offer). In this manner, the system indicates to the borrower what each offer will cost the borrower on a monthly basis based both on the information entered by the borrower in boxes 1507, 1508 and 1509 and the information (such as term, rate, etc.) that is included in the offer. In a preferred embodiment, this information is viewable by all users (registered and unregistered). To make an offer on a custom property profile, a lender would click the “make an offer” button 1510 (refer to discussion of FIG. 12, above). To become a listening lender, a lender would click the “become listening lender” button 1511.

FIG. 16 is a screen shot of the loan platform personal page of the present invention. The loan platform personal page is a username- and password-protected graphical user interface specific to each borrower and lender (only registered users have access to the loan platform personal page). This page is also real-time in that any custom property profiles for which the lender has placed a bid (made an offer) or for which the lender has elected to become a listening lender (i.e., those properties being “watched” by the lender) are displayed in separate display boxes in the dynamic display area 1604 (see FIG. 17 to see how separate display boxes are displayed in the dynamic display area). These separate display boxes are refreshed whenever a custom property profile receives a new loan offer, comment, document or photo. Logging into this page can be accomplished by selecting the “my profile” button 1309 on the home page (FIG. 13), which will take the user to the user profile page (FIG. 14). Once the user has correctly entered his username 1403 and password 1404, the user will be directed to his loan platform personal page (FIG. 16).

The loan platform personal page is a customizable graphical user interface that dynamically changes based on certain actions taken by the user, as described above; these actions result in the appearance of different display boxes in the dynamic display area 1604 (see FIG. 16A). All registered users can choose display windows from the menus provided in the following boxes: 1601 for functions specific to a borrower, 1602 for functions specific to a lender, and 1603 for administrative functions available to all registered users for managing their profile and account. Whichever function is selected from any of the boxes, that selection will display in the dynamic display area 1604.

The borrower options 1601 either link the borrower to specific functions included in the main borrower routine (see FIG. 2) or allow the user to elect to have certain display boxes appear in the display area 1604. From the borrower options box 1601, borrowers can select “list property,” which directs the user to FIG. 18 to being the process for listing a custom property profile. The borrower also can select “current ads,” which will add to the dynamic display area 1604 a display box titled “current ads” that displays any ads the borrower currently has listed. This allows the borrower to access, maintain and update one or more custom property profiles, including uploading photos, adding or removing documents, and changing data for a particular custom property profile (see FIG. 7). Borrowers can select “inactive ads” from box 1601 to display any ads they have previously delisted (see FIG. 8); when “inactive ads” is selected, another box titled “inactive ads” displays in dynamic display area 1604. The borrower can select any of the displayed delisted ads and re-list it, as described above.

The lender options 1602 allows a lender to browse properties, view those properties for which the lender has become a “listening lender” (i.e., those properties the lender is “watching”), view those properties for which the lender has made offers, view those properties for which the lender has extended a loan, and view those properties for which the lender made an offer but did not fund the loan. The “browse properties” function takes the lender to the search results page (FIG. 24) to perform the browse, search or loan wizard functions described above. The “watching” function causes a box titled “watching” to display in the dynamic display area 1604 (see FIG. 16A); this box displays a grid view of all custom property profiles for which the lender is a “listening lender.” The “active bids” function causes a box titled “active bids” to display in the dynamic display area 1604 (see FIG. 16A); this box displays a grid view of all custom property profiles for which the lender has made offers and for which the end date has not already passed or for which an offer has not already been accepted.

The “suspended offers” function causes a box titled “suspended offers” to display in the dynamic display area 1604; this box contains all bids that are suspended as a result of an offer by this same lender being accepted. Suspended offers may be reactivated as described above in connection with FIG. 3, step 1250. The “funded” function causes a box titled “loans funded” to display in the dynamic display area 1604. In a preferred embodiment, if a registered user has successfully funded a loan or multiple loans using the present invention, the “loans funded” box displays the one or multiple funded loans. This display is preferably in a grid view format with each row featuring a separate property and associated loan information and each column representing financial information, such as total loan amount, loan origination date, current balance of loan, recent monthly payment, and other payment or defaulted payment history information. The “loans funded” box will serve as a means by which lenders can monitor the repayment status of their loans. The “didn't fund” function causes a box titled “declined offers” to display in the dynamic display area 1604; this box displays a grid view of all custom property profiles for properties with respect to which the lender made an offer that was not accepted by the borrower.

By clicking on the “administrative/password” function in the “my profile” box 1603, the user may access functions for managing his password, registered email account, secret questions used in setting a new password, and personal contact information. All of this information will be displayed in box 1604.

The loan platform personal page further comprises a “browse properties” button 1605 that allows both borrowers and lenders to browse properties, as described above, and a “loan wizard” button 1606 that may also be accessed from the home page (FIG. 13). The loan wizard function enables lenders to search the properties database to find existing loan opportunities having criteria matching their personal loan criteria. Borrowers can also use the loan wizard function to benchmark, or compare, offers being made on similar properties so that they can get an idea as to the type of loan and terms that might be available.

All screen shots provided in connection with this application are for illustrative purposes only and not intended to be limiting in any respect. The present invention is not limited to any particular graphical user interface as long as the functionality described herein is provided.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A computer-implemented system for real estate collateralized private party loan transactions comprising a database of custom property profiles that are posted by borrowers seeking to obtain financing;
wherein each custom property profile comprises desired loan amount, type of financing sought by the borrower, purpose of the loan, and designated title company and closing agent;
wherein the system allows posting borrowers to upload photos and documents in connection with their custom property profiles;
wherein the system allows lenders to bid on custom property profiles by offering to make loans based on terms set by the lender;
wherein a lender may offer to make a loan on more than one custom property profile at a time;
wherein if a borrower accepts an offer made by a lender, the system automatically suspends all other unexpired offers made by the lender; and
wherein the lender may reactivate a loan offer that has been suspended.

2. The system of claim 1, wherein the system allows the posting borrower to add or remove photos and documents from the custom property profile after it is posted; and
wherein lenders who have made loan offers on the custom property profile are automatically notified of the addition or removal of photos and documents.

3. The system of claim 1, wherein the system allows the posting borrower to modify the desired loan amount, type of financing sought by the borrower, and purpose of the loan; and
wherein the custom property profile is automatically delisted if the posting borrower modifies the desired loan amount, type of financing sought, or purpose of the loan.

4. The system of claim 1, wherein the system allows the posting borrower to delist the custom property profile at any time.

5. The system of claim 1, wherein the custom property profile includes an expiration date, and the custom property profile is automatically delisted after the expiration date.

6. The system of claim 1, wherein the documents uploaded by the borrower include appraisals, home inspection documents, title insurance policies and title reports.

7. The system of claim 1, further comprising an automated notification feature that determines what types of documents should be uploaded in connection with a particular custom property profile and prompts the posting borrower to upload such documents.

8. The system of claim 1, wherein when an offer is accepted by a posting borrower, all other lenders who have made offers on the same custom property profile are automatically notified, and a request for closing is sent automatically to the designated title company and closing agent.

9. The system of claim 1, wherein lenders may change the terms of their loan offers in real-time.

10. The system of claim 1, wherein all loan offers are viewable by registered and non-registered users.

11. The system of claim 1, further comprising a discussion feature that allows borrowers and lenders to communicate directly with one another through discussion comments.

12. The system of claim 11, wherein the discussion comments are viewable by registered and non-registered users.

13. The system of claim 1, wherein each custom property profile further comprises a document vault;
wherein the documents uploaded by the posting borrower in connection with the custom property profile are contained in the document vault;
wherein the system allows a lender to request access to documents in the document vault;
wherein the system allows the posting borrower to grant or decline a request for access to documents in the document vault; and
wherein if the posting borrower grants a lender access to the documents in the document vault, the system automatically provides the lender with access to the documents in the document vault.

14. The system of claim 1, wherein a lender may elect listening lender status with respect to one or more custom property profiles; and
wherein a lender with listening lender status is automatically notified of offers made, newly uploaded photos, newly uploaded documents, and new discussion comments with respect to those custom property profiles for which the lender is a listening lender.

15. The system of claim 1, wherein the system calculates an internal score for each offer made on a custom property profile; and
wherein the internal score represents an estimated rate of return for the offer.

16. The system of claim 15, wherein the system applies the following algorithm to calculate the internal score:
$$S = \frac{\frac{{P}_{0} * r * N}{1 - {( 1 + r )}^{- N}} + ϕ * {P}_{0} - C}{{P}_{0}} - 1$$
wherein C is closing costs paid by the lender, r is monthly interest rate, N is number of monthly payment, P₀ is principal, φ is points and S is the internal score.

17. The system of claim 1, wherein the system allows the posting borrower to rank offers made on the custom property profile based on parameters set by the borrower; and
wherein the borrower's ranking of offers is viewable by registered and non-registered users.

18. The system of claim 1, wherein the system calculates estimated monthly payments for each offer made on a custom property profile.

19. The system of claim 18, wherein the estimated monthly payments are viewable by registered and non-registered users.

20. The system of claim 15, further comprising a loan wizard;
wherein the system allows a borrower to provide feedback on loans made with respect to custom property profiles posted by the borrower; and
wherein the loan wizard takes borrower feedback into consideration in automatically identifying for a lender loan opportunities that meet criteria set by the lender and where the borrower is most likely to accept an offer from the lender.

21. A computer-implemented method for consummating real estate collateralized private party loan transactions comprising:
providing a database of custom property profiles that are posted by borrowers seeking to obtain financing, wherein each custom property profile comprises desired loan amount, type of financing sought by the borrower, purpose of the loan, and designated title company and closing agent;
allowing posting borrowers to upload photos and documents in connection with their custom property profiles;
allowing lenders to bid on custom property profiles by offering to make loans based on terms set by the lender;
allowing a lender to offer to make a loan on more than one custom property profile at a time;
if a borrower accepts an offer made by a lender, automatically suspending all other unexpired offers made by the lender; and
allowing the lender to reactivate a loan offer that has been suspended.

22. The method of claim 1, further comprising allowing the posting borrower to add or remove photos and documents from the custom property profile after it is posted; and
automatically notifying lenders who have made loan offers on the custom property profile of the addition or removal of photos and documents.

23. The method of claim 1, further comprising allowing the posting borrower to modify the desired loan amount, type of financing sought by the borrower, and purpose of the loan; and
automatically delisting the custom property profile if the posting borrower modifies the desired loan amount, type of financing sought, or purpose of the loan.

24. The method of claim 1, further comprising allowing the posting borrower to delist the custom property profile at any time.

25. The method of claim 1, wherein the custom property profile includes an expiration date, further comprising automatically delisting the custom property profile after the expiration date.

26. The method of claim 1, wherein the documents uploaded by the borrower include appraisals, home inspection documents, title insurance policies and title reports.

27. The method of claim 1, further comprising providing an automated notification feature that determines what types of documents should be uploaded in connection with a particular custom property profile and prompts the posting borrower to upload such documents.

28. The method of claim 1, further comprising, when an offer is accepted by a posting borrower, automatically notifying all other lenders who have made offers on the same custom property profile, and automatically sending a request for closing to the designated title company and closing agent.

29. The method of claim 1, further comprising enabling lenders to change the terms of their loan offers in real-time.

30. The method of claim 1, further comprising allowing both registered and non-registered users to view all loan offers.

31. The method of claim 1, further comprising providing a discussion feature that allows borrowers and lenders to communicate directly with one another through discussion comments.

32. The method of claim 31, wherein the discussion comments are viewable by registered and non-registered users.

33. The method of claim 1, wherein each custom property profile further comprises a document vault;
wherein the documents uploaded by the posting borrower in connection with the custom property profile are contained in the document vault;
further comprising allowing a lender to request access to documents in the document vault;
further comprising allowing the posting borrower to grant or decline a request for access to documents in the document vault; and
if the posting borrower grants a lender access to the documents in the document vault, further comprising automatically providing the lender with access to the documents in the document vault.

34. The method of claim 1, further comprising allowing a lender to elect listening lender status with respect to one or more custom property profiles; and
further comprising automatically notifying a lender with listening lender status of offers made, newly uploaded photos, newly uploaded documents, and new discussion comments with respect to those custom property profiles for which the lender is a listening lender.

35. The method of claim 1, further comprising calculating an internal score for each offer made on a custom property profile;
wherein the internal score represents an estimated rate of return for the offer.

36. The method of claim 35, further comprising applying the following algorithm to calculate the internal score:
$$S = \frac{\frac{{P}_{0} * r * N}{1 - {( 1 + r )}^{- N}} + ϕ * {P}_{0} - C}{{P}_{0}} - 1$$
wherein C is closing costs paid by the lender, r is monthly interest rate, N is number of monthly payment, P₀ is principal, φ is points and S is the internal score.

37. The method of claim 1, further comprising allowing the posting borrower to rank offers made on the custom property profile based on parameters set by the borrower; and
allowing both registered and non-registered users to view the borrower's ranking of offers.

38. The method of claim 1, further comprising calculating estimated monthly payments for each offer made on a custom property profile.

39. The method of claim 38, further comprising allowing both registered and non-registered users to view the estimated monthly payments.

40. The method of claim 15, further comprising allowing a borrower to provide feedback on loans made with respect to custom property profiles posted by the borrower;
further comprising providing a loan wizard that takes into consideration borrower feedback in automatically identifying for a lender loan opportunities that meet criteria set by the lender and where the borrower is most likely to accept an offer from the lender.
